(19) United States
(12) Patent Application Publication
(10) Pub. No.: US 2026/0195150 A1
(43) Pub. Date: Jul. 9, 2026

(54) ELECTRONIC DEVICE FOR EXECUTING PLURALITY OF APPLICATIONS IN FOREGROUND

(71) Applicant: Samsung Electronics Co., Ltd., Suwon-si (KR)

(72) Inventors: Sangyeol DO, Suwon-si (KR); Dasom LEE, Suwon-si (KR); Moonsoo CHANG, Suwon-si (KR); Taehwa HONG, Suwon-si (KR); Dahyun KIM, Suwon-si (KR); Dongchurl KIM, Suwon-si (KR); Youngjae KIM, Suwon-si (KR); Taeyoon AN, Suwon-si (KR)

(21) Appl. No.: 19/441,344

(22) Filed: Jan. 6, 2026

Related U.S. Application Data
(63) Continuation of application No. PCT/KR2025/020969, filed on Dec. 8, 2025.

(30) Foreign Application Priority Data
Jan. 7, 2025 (KR) 10-2025-0002125
Mar. 6, 2025 (KR) 10-2025-0029057

(51) Int. Cl. G06F 9/451; G06F 3/0484; G06F 9/54

(52) U.S. Cl. CPC G06F 9/451; G06F 3/0484; G06F 9/542

(57) ABSTRACT

An electronic device is provided. The electronic device includes a display, memory for storing at least one computer program including a plurality of instructions, and at least one processor communicatively coupled to the display and the memory, and the at least one computer program, when executed individually or collectively by the at least one processor, cause the electronic device to divide the display into a first part and a second part in case that a predetermined first condition is satisfied, allocate one of the first part or the second part to a first application running in a foreground, allocate another of the first part or the second part to a second application running in the foreground, and distribute events of the first and second applications so as to be processed independently of each other.

### CROSS-REFERENCE TO RELATED APPLICATION(S)

This application is a continuation application, claiming priority under 35 U.S.C. § 365(c), of an International application No. PCT/KR 2025/020969, filed on Dec. 8, 2025, which is based on and claims the benefit of a Korean patent application number 10-2025-0002125, filed on Jan. 7, 2025, in the Korean Intellectual Property Office, and of a Korean patent application number 10-2025-0029057, filed on Mar. 6, 2025, in the Korean Intellectual Property Office, the disclosure of each of which is incorporated by reference herein in its entirety.

### TECHNICAL FIELD

The disclosure relates to an electronic device and a method of operating the electronic device. More particularly, the disclosure relates to an electronic device and a technique for executing a plurality of applications of the electronic device in the foreground.

### BACKGROUND ART

An application may be executed in the foreground or in the background. When executing a plurality of applications simultaneously, an electronic device may execute one application in the foreground and the remaining applications in the background. When a user input is received for an application running in the background, the electronic device may execute the application, which is running in the background, in the foreground and execute the application, which is running in the foreground, in the background.

The above information is presented as background information only to assist with an understanding of the disclosure. No determination has been made, and no assertion is made, as to whether any of the above might be applicable as prior art with regard to the disclosure.

### DISCLOSURE

### Technical Problem

When an electronic device is used by a plurality of users, user inputs from the plurality of users may be received on the display. The electronic device may switch the states (e.g., foreground or background) of the plurality of applications according to user inputs received from the plurality of users. The plurality of users may experience inconvenience due to the frequent state switching between the plurality of applications. For example, the plurality of users may experience delays resulting from the repeated reallocation of system resources due to the repeated switching between the foreground and background states.

Aspects of the disclosure are to address at least the above-mentioned problems and/or disadvantages and to provide at least the advantages described below. Accordingly, an aspect of the disclosure is to provide an electronic device and a technique for executing a plurality of applications of the electronic device in the foreground.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes a display, memory for storing at least one computer program including a plurality of instructions, at least one processor communicatively coupled to the display and the memory, wherein the at least one computer program, when executed individually or collectively by the at least one processor, cause the electronic device to divide the display into a first part and a second part if predetermined first conditions are satisfied, allocate one of the first part or the second part to a first application running in a foreground, allocate another of the first part or the second part to a second application running in the foreground, and distribute events of the first and second applications so as to be processed independently of each other.

In accordance with another aspect of the disclosure, a method for executing a plurality of applications in a foreground in an electronic device is provided. The method includes dividing a display into a first part and a second part in case that a predetermined first condition is satisfied, allocating one of the first part or the second part to a first application running in the foreground, allocating another of the first part or the second part to a second application running in the foreground, and distributing events of the first and second applications so as to be processed independently of each other.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include dividing a display of the electronic device into a first part and a second part, in case that a predetermined first condition is satisfied, allocating one of the first part or the second part to a first application running in a foreground, allocating another of the first part or the second part to a second application running in the foreground, and distributing events of the first and second applications so that each of the events is processed independently.

### Advantageous Effects

The operating system of an electronic device utilizes a plurality of components that process events from a plurality of applications while executing the plurality of applications. Each of the plurality of components is allocated one application and processes events of the allocated application. The operating system of the electronic device simultaneously executes applications corresponding to the plurality of users in the foreground through the plurality of components. The electronic device prevents inconvenience caused by state transitions among the plurality of applications by processing events of each of the plurality of applications without switching the states of the plurality of applications.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device capable of performing the operations according to an embodiment of the disclosure;

FIG. 2A is a schematic diagram of a foldable electronic device in an unfolded state, when viewed from the front, according to an embodiment of the disclosure;

FIG. 2B is a schematic diagram of a foldable electronic device in an unfolded state, when viewed from the rear, according to an embodiment of the disclosure;

FIG. 3A is a schematic diagram illustrating a state of a foldable electronic device in which a second housing and a third housing are folded according to an embodiment of the disclosure;

FIG. 3B is a schematic diagram illustrating a state of a multi-foldable electronic device in which a first housing, a second housing, and a third housing are folded according to an embodiment of the disclosure;

FIG. 4 is a diagram illustrating a situation in which an electronic device executes a plurality of applications according to an embodiment of the disclosure;

FIG. 5 is a block diagram of an electronic device according to an embodiment of the disclosure;

FIG. 6 is a diagram illustrating a foldable electronic device according to an embodiment of the disclosure;

FIG. 7 is a block diagram of an electronic device according to an embodiment of the disclosure;

FIG. 8 is a diagram illustrating components included in an operating system according to an embodiment of the disclosure;

FIG. 9 is a diagram illustrating an operation of an operating system to output an application execution screen to a display in host mode or guest mode according to an embodiment of the disclosure;

FIGS. 10A and 10B are diagrams illustrating an operation of an operating system to process user input in host mode or guest mode according to various embodiments of the disclosure;

FIG. 11 is a diagram illustrating an operation of an operating system to register a notification in host mode or guest mode according to an embodiment of the disclosure;

FIG. 12 is a diagram illustrating an operation of an operating system to process a Bluetooth connection request in host mode or guest mode according to an embodiment of the disclosure;

FIG. 13 is a diagram illustrating a folding state of a foldable electronic device according to an embodiment of the disclosure;

FIGS. 14A and 14B are diagrams illustrating a user authentication operation of an electronic device that has determined to execute guest mode according to various embodiments of the disclosure;

FIG. 15 is a diagram illustrating a method in which an electronic device executing guest mode processes user input according to an embodiment of the disclosure;

FIG. 16 is a flowchart illustrating an operation in which an electronic device executes guest mode while in host mode according to an embodiment of the disclosure;

FIG. 17 is a flowchart illustrating an operation in which an electronic device processes touch input while in guest mode according to an embodiment of the disclosure; and

FIG. 18 is a flowchart illustrating an operation in which an electronic device executes host mode while in guest mode according to an embodiment of the disclosure.

Throughout the drawings, like reference numerals will be understood to refer to like parts, components, and structure.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

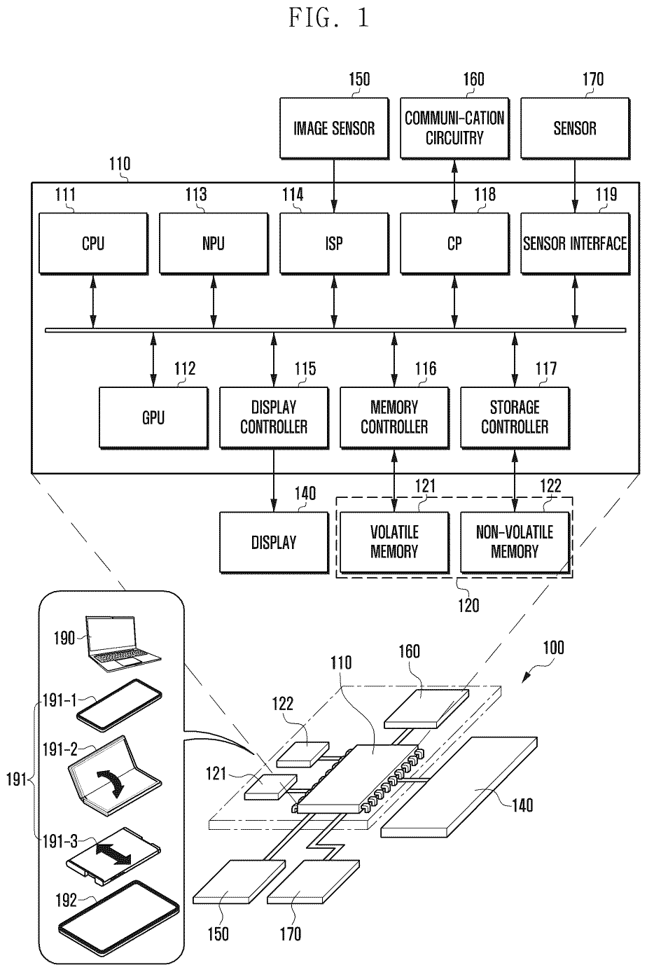

FIG. 1 illustrates a block diagram of an electronic device 100 capable of performing the operations according to an embodiment of the disclosure.

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

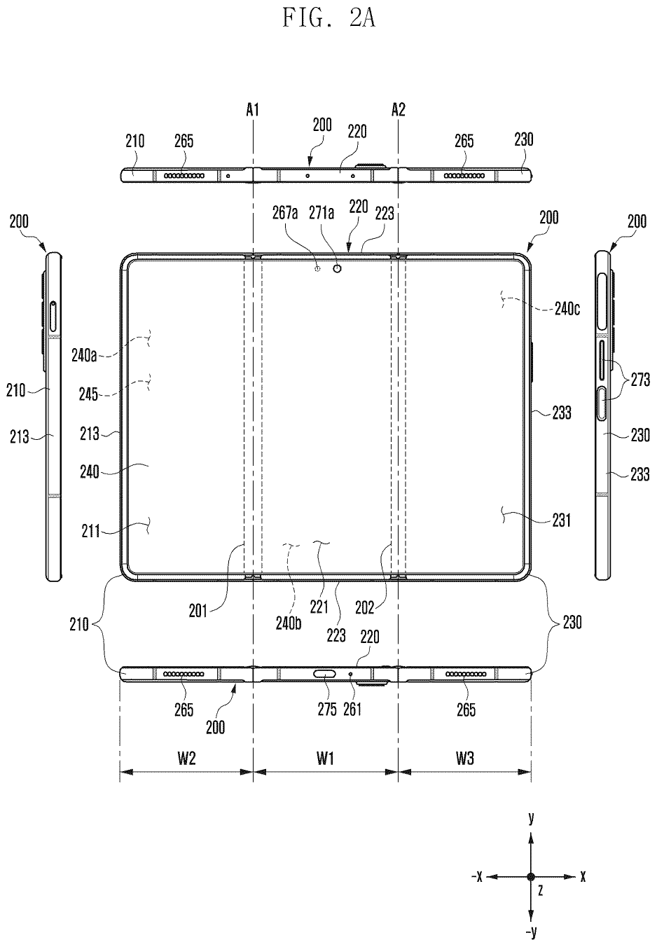

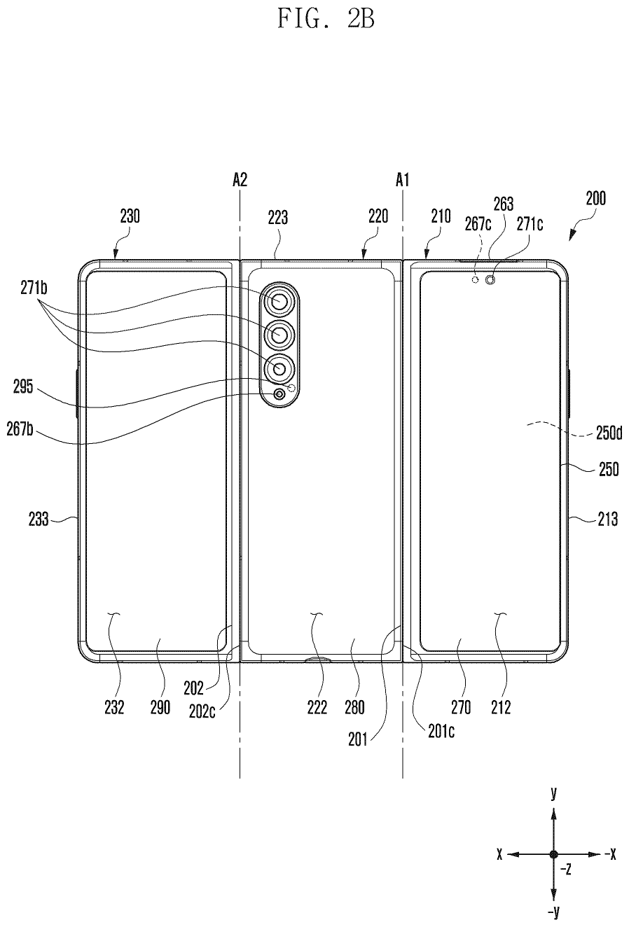

FIG. 2A is a schematic diagram of a foldable electronic device in an unfolded state, when viewed from the front, according to an embodiment of the disclosure.

FIG. 2B is a schematic diagram of a foldable electronic device in an unfolded state, when viewed from the rear, according to an embodiment of the disclosure.

According to various embodiments, the embodiments of the electronic device 100 disclosed in FIG. 1 may be included in embodiments of a foldable electronic device 200 (e.g., a multi-foldable electronic device) disclosed in FIGS. 2A and 2B. For example, the foldable electronic device 200 disclosed in FIGS. 2A and 2B may include the processor 110, memory 120, display 140, image sensor 150, communication circuitry 160, and/or sensor 170 disclosed in FIG. 1.

Referring to FIGS. 2A and 2B, a foldable electronic device 200 (e.g., a multi-foldable electronic device) according to an embodiment of the disclosure may include a first housing 210, a second housing 220, a third housing 230, a first hinge module 201, a second hinge module 202, and/or a flexible display 240.

According to an embodiment, the second housing 220 may be disposed between the first housing 210 and the third housing 230. The first housing 210 may be coupled to a first side (e.g., in the −x-axis direction) of the second housing 220 so as to allow folding and unfolding. The third housing 230 may be coupled to a second side (e.g., in the x-axis direction) of the second housing 220 so as to allow folding and unfolding. For example, a first side (e.g., in the −x-axis direction) of the second housing 220 may be operatively coupled to at least a portion of the first housing 210 via the first hinge module 201, and a second side (e.g., in the x-axis direction) thereof may be operatively coupled at least a portion of the third housing 230 via the second hinge module 202.

According to an embodiment, the first housing 210 may be foldably coupled to the first side (e.g., in the −x-axis direction) of the second housing 220. The first hinge module 201 may be foldably coupled between the first housing 210 and the second housing 220. The first hinge module 201 may be disposed such that the first housing 210 and the second housing 220 are capable of being folded or unfolded relative to each other. The first hinge module 201 may include a hinge device, a hinge member, a hinge plate, or a hinge assembly. The first housing 210 and the second housing 220 may be coupled to be rotatable about a first folding axis A1 using the first hinge module 201.

According to an embodiment, the first hinge module 201 may be covered by a first hinge cover 201c (e.g., a first hinge housing). The first hinge cover 201c may be configured to cover the first hinge module 201. The first hinge cover 201c may be disposed between the first housing 210 and the second housing 220. The first hinge cover 201c may cover the first hinge module 201 so that the first hinge module 201 is invisible from the outside. The first hinge cover 201c may be covered by at least a portion of the first housing 210 and the second housing 220, or visually exposed to the outside depending on whether the first housing 210 and the second housing 220 are in an unfolded or folded state. For example, when the first housing 210 and the second housing 220 are in an unfolded state, at least a portion of the first hinge module 201 may be covered by the first housing 210 and the second housing 220 and may not be substantially exposed.

According to an embodiment, the third housing 230 may be foldably coupled to the second side (e.g., in the x-axis direction) of the second housing 220. The second hinge module 202 may be foldably coupled between the second housing 220 and the third housing 230. The second hinge module 202 may be disposed such that the second housing 220 and the third housing 230 are capable of being folded or unfolded relative to each other. The second hinge module 202 may include a hinge device, a hinge member, a hinge plate, or a hinge assembly. The second housing 220 and the third housing 230 may be coupled to be rotatable about a second folding axis A2 using the second hinge module 202.

According to an embodiment, the second hinge module 202 may be covered by a second hinge cover 202c (e.g., a second hinge housing). The second hinge cover 202c may be configured to cover the second hinge module 202. The second hinge cover 202c may be disposed between the second housing 220 and the third housing 230. The second hinge cover 202c may cover the second hinge module 202 so that the second hinge module 202 is invisible from the outside. The second hinge cover 202c may be covered by at least a portion of the second housing 220 and the third housing 230, or visually exposed to the outside depending on whether the second housing 220 and the third housing 230 are in an unfolded or folded state. For example, when the second housing 220 and the third housing 230 are in an unfolded state, the second hinge cover 202c may be partially covered or partially exposed by the second housing 220 and the third housing 230.

According to an embodiment, in the foldable electronic device 200 (e.g., a multi-foldable electronic device), the third housing 230 may be first folded relative to the second housing 220 via the second hinge module 202, and the first housing 210 may be subsequently folded relative to the second housing 220 via the first hinge module 201. For example, the third housing 230 may be folded relative to the second housing 220 via the second hinge module 202 in an in-folding manner. For example, the third housing 230 may be folded relative to the second housing 220 while rotating in the z-axis direction and the −x-axis direction via the second hinge module 202. For example, the first housing 210 may be folded relative to the second housing 220 via the first hinge module 201 in an in-folding manner. For example, the first housing 210 may be folded relative to the second housing 220 while rotating in the z-axis direction and the x-axis direction via the first hinge module 201.

According to an embodiment, the width W3 of the third housing 230 in the horizontal direction (e.g., in the x-axis and −x-axis directions) may be configured to be smaller than the width W1 of the second housing 220 in the horizontal direction (e.g., in the x-axis and −x-axis directions). The width W1 of the second housing 220 in the horizontal direction (e.g., in the x-axis and −x-axis directions) may be configured to be substantially the same as the width W2 of the first housing 210 in the horizontal direction (e.g., in the x-axis and −x-axis directions). According to various embodiments, the width W2 of the first housing 210 in the horizontal direction (e.g., in the x-axis and −x-axis directions) may be configured to be greater than the width W1 of the second housing 220 in the horizontal direction (e.g., in the x-axis and −x-axis directions).

According to an embodiment, the second housing 220 and the third housing 230 may be disposed on both sides of the second folding axis A2 on which the second hinge module 202 is disposed, and may have an asymmetrical shape with respect to the second folding axis A2. According to various embodiments, the second housing 220 and the third housing 230 may have a symmetrical shape with respect to the second folding axis A2. The angle or distance between the second housing 220 and the third housing 230 may vary depending on whether the foldable electronic device 200 is in an unfolded state, a folded state, or an intermediate state.

According to an embodiment, the second housing 220 and the first housing 210 may be disposed on both sides of the first folding axis A1 on which the first hinge module 201 is disposed, and may have a substantially symmetrical shape with respect to the first folding axis A1. According to various embodiments, the second housing 220 and the first housing 210 may have an asymmetrical shape with respect to the first folding axis A1. The angle or distance between the second housing 220 and the first housing 210 may vary depending on whether the foldable electronic device 200 is in an unfolded state, a folded state, or an intermediate state.

According to an embodiment, the width of the first hinge module 201 may be configured to be greater than the width of the second hinge module 202. For example, in a case where the third housing 230 is first folded relative to the second housing 220, and the first housing 210 is folded relative to the second housing 220 so that the first housing 210 is placed on top of the third housing 230, the width of the first hinge module 201 may be configured to be greater than the width of the second hinge module 202. For example, the first hinge module 201 may be a first in-folding hinge, wide hinge, or big hinge that has a greater width than the second hinge module 202. For example, the second hinge module 202 may be a second in-folding hinge, slim hinge, or small hinge that has a smaller width than the first hinge module 201. In an embodiment, the first hinge module 201 may have a larger radius of curvature than the second hinge module 202. The second hinge module 202 may have a smaller radius of curvature than the first hinge module 201. In an embodiment, although the width of the first hinge module 201 is described as being greater than the width of the second hinge module 202, the disclosure is not limited thereto, and the width of the second hinge module 202 may be greater than the width of the first hinge module 201 depending on the type and/or operation of the foldable electronic device 200.

According to an embodiment, the flexible display 240 may be disposed on the first housing 210, the second housing 220, and the third housing 230. For example, the flexible display 240 may be disposed across at least a portion of the front faces (e.g., in the z-axis direction) of the first housing 210, the second housing 220, and the third housing 230. The flexible display 240 may be a first display, a foldable display, or a main display. According to various embodiments, a sub-display 250 may be disposed on the rear face (e.g., in the −z-axis direction) of the first housing 210. The sub-display 250 may be a second display or an auxiliary display.

In this document, the surface on which the flexible display 240 is disposed may be defined as a front face (e.g., in the z-axis direction) of the foldable electronic device 200, and the surface opposite the front face may be defined as a rear face (e.g., in the −z-axis direction) of the foldable electronic device 200. The surface surrounding the space between the front face (e.g., in the z-axis direction) and the rear face (e.g., in the −z-axis direction) may be defined as a lateral surface of the foldable electronic device 200.

According to an embodiment, the flexible display 240 may include a second display area 240b disposed in the second housing 220, a first display area 240a disposed in the first housing 210, and a third display area 240c disposed in the third housing 230 (e.g., the front face). The first display area 240a, the second display area 240b, and the third display area 240c may be formed integrally to configure the flexible display 240. According to various embodiments, when the foldable electronic device 200 is in the unfolded state, the flexible display 240 may be configured to be disposed on most of the front face (e.g., in the z-axis direction) of the foldable electronic device 200. At least a partial area of the flexible display 240 may be deformed into a flat or curved surface. The division of the first display area 240a, the second display area 240b, and the third display area 240c of the flexible display 240 may be physical divisions. The flexible display 240 may be formed as a single seamless and full-width screen. According to an embodiment, the sub-display 250 may include a fourth display area 250d. For example, the sub-display 250 may be disposed on the rear face (e.g., in the −z-axis direction) of the second housing 220.

According to an embodiment, when the foldable electronic device 200 is in the unfolded state, the first housing 210 may include a first surface 211 that is connected to at least a portion of the first hinge module 201 and disposed to face the front (e.g., in the z-axis direction) of the foldable electronic device 200, a second surface 212 that faces the opposite direction of the first surface 211, and/or a first lateral member 213 that surrounds at least a portion of a first space between the first surface 211 and the second surface 212.

According to an embodiment, when the foldable electronic device 200 is in the unfolded state, the second housing 220 may include a third surface 221 that is connected to at least a portion of the first hinge module 201 and the second hinge module 202, and disposed to face the front (e.g., in the z-axis direction) of the foldable electronic device 200, a fourth surface 222 that faces the opposite direction of the third surface 221, and/or a second lateral member 223 that surrounds at least a portion of a second space between the third surface 221 and the fourth surface 222.

According to an embodiment, when the foldable electronic device 200 is in the unfolded state, the third housing 230 may include a fifth surface 231 that is connected to at least a portion of the second hinge module 202 and disposed to face the front (e.g., in the z-axis direction) of the foldable electronic device 200, a sixth surface 232 that faces the opposite direction of the fifth surface 231, and/or a third lateral member 233 that surrounds at least a portion of a third space between the fifth surface 231 and the sixth surface 232.

According to various embodiments, when the foldable electronic device 200 is in the unfolded state, the first surface 211, the third surface 221, and the fifth surface 231 may face substantially the same direction (e.g., the z-axis direction). When the foldable electronic device 200 is in the unfolded state, the second surface 212, the fourth surface 222, and the sixth surface 232 may face substantially the same direction (e.g., the −z-axis direction).

According to various embodiments, when the second housing 220 and the third housing 230 of the foldable electronic device 200 are in the folded state, the third surface 221 and the fifth surface 231 may be disposed to face each other. When the first housing 210 is folded relative to the second housing 220 of the foldable electronic device 200, and the first housing 210 is disposed on top of the third housing 230 (e.g., in the z-axis direction), the first surface 211 of the first housing 210 and the sixth surface 232 of the third housing 230 may be disposed to face each other.

According to various embodiments, the foldable electronic device 200 may include a recess 245 formed to accommodate the flexible display 240 through the structural combination of the first housing 210, the second housing 220, and the third housing 230. The recess 245 may have substantially the same size as the flexible display 240.

According to various embodiments, when the foldable electronic device 200 is in the unfolded state, the first housing 210, the second housing 220, and the third housing 230 may be disposed to form an angle of about 180°, and the first display area 240a, the second display area 240b, and the third display area 240c of the flexible display 240 may be disposed to form substantially the same plane, thereby facing substantially the same direction (e.g., the z-axis direction). The fourth display area 250d of the sub-display 250 may be disposed to face the opposite direction of the third display area 240c.

According to various embodiments, the first housing 210 and the second housing 220 may be maintained at a designated folding angle between the folded state and the unfolded state using the first hinge module 201 (e.g., a free stop function). In various embodiments, the first housing 210 may also be rotated, using the first hinge module 201, to move toward the fourth surface 222 (e.g., the rear face) of the second housing 220 while being pressed in the unfolding direction (e.g., the −z-axis direction) based on a designated inflection angle.

According to various embodiments, the second housing 220 and the third housing 230 may be maintained at a designated folding angle between the folded state and the unfolded state using the second hinge module 202. In various embodiments, the third housing 230 may also be rotated, using the second hinge module 202, to move toward the fourth surface 222 (e.g., the rear face) of the second housing 220 while being pressed in the unfolding direction (e.g., the −z-axis direction) based on a designated inflection angle.

According to various embodiments, the flexible display 240 may be disposed to be supported by the third surface 221 of the second housing 220, the first hinge module 201, the first surface 211 of the first housing 210, the second hinge module 202, and the fifth surface 231 of the third housing 230. In an embodiment, the sub-display 250 (e.g., the fourth display area 250 d) may be disposed in the inner space of the first housing 210 so as to be at least partially visible from the outside through the second surface 212. In various embodiments, the sub-display 250 may also be disposed in the inner space of the third housing 230 so as to be visible from the outside through the sixth surface 232.

According to an embodiment, the flexible display 240 may be primarily used when the foldable electronic device 200 is in the unfolded state, and the sub-display 250 may be primarily used when the multi-foldable electronic device 200 is in the folded state.

According to an embodiment, the foldable electronic device 200 may include a second rear cover 280 disposed on the fourth surface 222 of the second housing 220, a first rear cover 270 disposed on the second surface 212 of the first housing 210, and/or a third rear cover 290 disposed on the sixth surface 232 of the third housing 230. In various embodiments, at least a portion of the second rear cover 280 may be formed integrally with a portion of the second lateral member 223. In various embodiments, at least a portion of the first rear cover 270 may be formed integrally with a portion of the first lateral member 213. In various embodiments, at least a portion of the third rear cover 290 may be formed integrally with a portion of the third lateral member 233. According to an embodiment, at least one of the first rear cover 270, the second rear cover 280, and the third rear cover 290 may be formed of a substantially transparent plate (e.g., a glass plate including various coating layers, or a polymer plate) or an opaque plate.

According to various embodiments, the second rear cover 280 may be formed of an opaque plate, such as coated or tinted glass, ceramic, polymer, metal (e.g., aluminum, stainless steel (STS), or magnesium), or a combination of at least two of the above materials. According to various embodiments, the first rear cover 270 may be formed of a substantially transparent plate, such as glass or polymer. According to various embodiments, the third rear cover 290 may be formed of an opaque plate, such as coated or tinted glass, ceramic, polymer, metal (e.g., aluminum, stainless steel (STS), or magnesium), or a combination of at least two of the above materials. The sub-display 250 (e.g., the fourth display area 250d) may be disposed in the inner space of the first housing 210 so as to be visible from the outside through the first rear cover 270.

According to various embodiments, the foldable electronic device 200 may include at least one of an input module 261, audio output modules 263 and 265, sensor modules 267a, 267b, and 267c, camera modules 271a, 271b, and 271c, a key input device 273, an indicator (not shown), or a connector port 275. In various embodiments, the foldable electronic device 200 may exclude at least one of the above-described components or may further include at least one other component.

According to an embodiment, the input module 261 may include at least one microphone disposed to detect the direction of sound. The input module 261 may include the image sensor 150 disclosed in FIG. 1.

According to an embodiment, the audio output modules 263 and 265 may include at least one speaker. The audio output modules 263 and 265 may include a call receiver 263 disposed through the second surface 212 of the first housing 210, and a speaker 265 disposed in a part of the upper portion (e.g., in the y-axis direction) and lower portion (e.g., in the −y-axis direction) of the first lateral member 213 of the first housing 210 and/or in a part of the upper portion (e.g., in the y-axis direction) and lower portion (e.g., in the −y-axis direction) of the third lateral member 233 of the third housing 230.

According to an embodiment, the input module 261, the audio output modules 263 and 265, and the connector port 275 may be disposed in the space of the first housing 210, the second housing 220, and/or the third housing 230, and may be exposed to the external environment through at least one hole formed in the first housing 210, the second housing 220, and/or the third housing 230. In an embodiment, the holes formed in the first housing 210, the second housing 220, and/or the third housing 230 may be used in common for the input module 261 and the audio output modules 263 and 265. In an embodiment, the audio output modules 263 and 265 may include a speaker (e.g., a piezo speaker) that operates without the holes formed in the first housing 210 and/or the third housing 230.

According to various embodiments, the camera modules 271a, 271b, and 271c may include a first camera module 271a disposed on the third surface 221 of the second housing 220, a second camera module 271b disposed on the fourth surface 222 of the second housing 220, and/or a third camera module 271c disposed on the second surface 212 of the first housing 210. According to an embodiment, the foldable electronic device 200 may include a flash 295 disposed near the second camera module 271b. The flash 295 may include, for example, a light-emitting diode or a xenon lamp. According to an embodiment, the camera modules 271a, 271b, and 271c may include one or more lenses, an image sensor, and/or an image signal processor. In an embodiment, at least one of the camera modules 271a, 271b, and 271c may include two or more lenses (e.g., wide-angle and telephoto lenses) and image sensors, and may be disposed together on one surface of the first housing 210, the second housing 220, and/or the third housing 230. For example, the camera modules 271a, 271b, and 271c may include the image sensor 150 disclosed in FIG. 1.

According to an embodiment, the sensor modules 267a, 267b, and 267c may generate electrical signals or data values corresponding to the internal operating state of the foldable electronic device 200 or the external environmental state. According to various embodiments, the sensor modules 267a, 267b, and 267c may include a first sensor module 267a disposed on the third surface 221 of the second housing 220, a second sensor module 267b disposed on the fourth surface 222 of the second housing 220, and/or a third sensor module 267c disposed on the second surface 212 of the first housing 210. For example, the sensor modules 267a, 267b, and 267c may include the sensor 170 disclosed in FIG. 1.

According to various embodiments, the foldable electronic device 200 may further include other sensor modules that are not shown, for example, at least one of a 6-axis sensor (e.g., an acceleration sensor and a gyro sensor), an angle detection sensor, a Hall sensor, an angular velocity sensor, a folding and unfolding detection sensor, a proximity sensor, a barometric pressure sensor, a magnetic sensor, a biometric sensor, a temperature sensor, a humidity sensor, a gesture sensor, a grip sensor, a color sensor, an infrared (IR) sensor, an illuminance sensor, an ultrasonic sensor, an iris recognition sensor, a distance detection sensor (e.g., a time-of-flight (TOF) sensor or a light detection and ranging (LiDAR) sensor), and a fingerprint recognition sensor.

According to an embodiment, the key input device 273 may be disposed to be exposed to the outside through the third lateral member 233 of the third housing 230. In an embodiment, the key input device 273 may also be disposed to be exposed to the outside through the first lateral member 213 of the first housing 210. In an embodiment, the foldable electronic device 200 may exclude the entirety or some of the key input device 273, and the excluded key input device 273 may be implemented in other forms, such as soft keys, on the flexible display 240 and/or the sub-display 250. In various embodiments, the key input device 273 may be implemented using a pressure sensor and/or touch sensor included in the flexible display 240 and/or the sub-display 250. In an embodiment, the key input device 273 may include a power button and/or a volume control button of the foldable electronic device 200.

According to an embodiment, the connector port 275 may include a connector (e.g., a USB connector or an IF module (interface connector port module)) for transmitting and receiving power and/or data to and from an external electronic device. In an embodiment, the connector port 275 may perform a function for transmitting and receiving audio signals to and from an external electronic device, or may further include a separate connector port (e.g., an ear jack hole) for transmitting and receiving audio signals. For example, the connector port 275 may be formed on a portion of the second lateral member 223 of the second housing 220.

According to various embodiments, at least one camera module 271a or 271c of the camera modules 271a, 271b, and 271c, at least one sensor module 267a or 267c of the sensor modules 267a, 267b, and 267c, and/or an indicator may be disposed to be exposed through at least one display 240 or 250. For example, at least one camera module 271a or 271c, at least one sensor module 267a or 267c, and/or an indicator may be disposed under the active area (display area) of at least one display 240 or 250 in the inner space of at least one housing 210, 220, or 230 so as to be in contact with the external environment through an opening formed up to the cover member (e.g., a window layer (not shown) of the flexible display 240 and/or the first rear cover 270) or a transparent area.

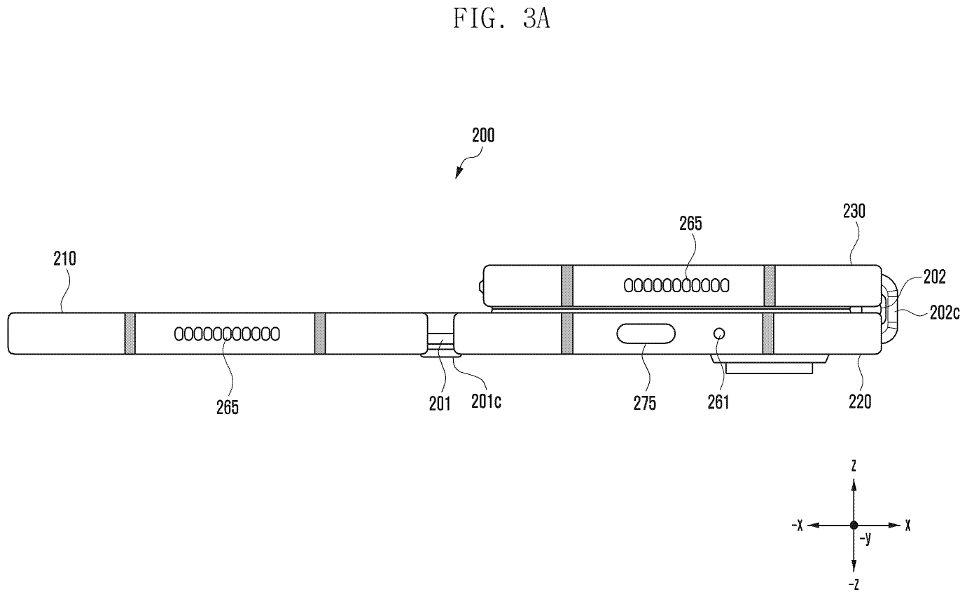

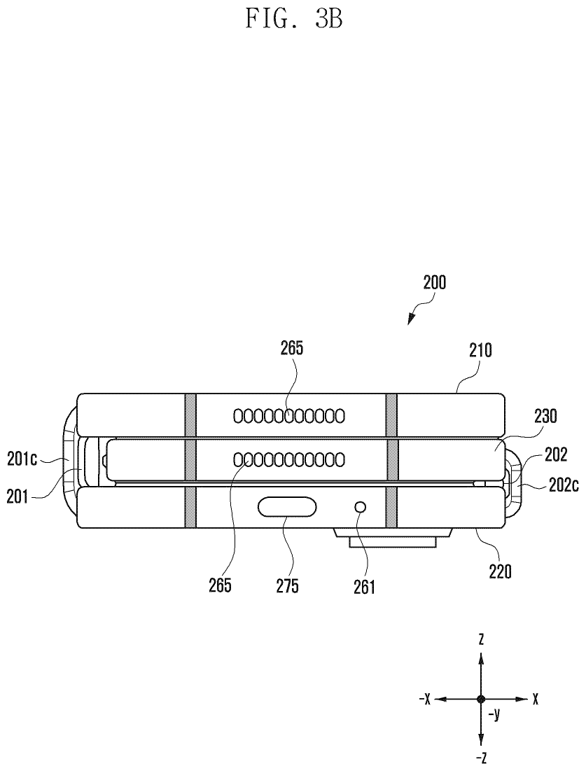

FIG. 3A is a schematic diagram illustrating a state of a foldable electronic device in which a second housing and a third housing are folded according to an embodiment of the disclosure.

FIG. 3B is a schematic diagram illustrating a state of a multi-foldable electronic device in which a first housing, a second housing, and a third housing are folded according to an embodiment of the disclosure.

According to an embodiment, FIG. 3A may be a drawing showing a state when viewed from the −y-axis direction, in which the third housing 230 of a foldable electronic device 200 (e.g., a multi-foldable electronic device) is folded toward the second housing 220, and the first housing 210 and the second housing 220 are unfolded. According to an embodiment, FIG. 3B may be a drawing showing a state, when viewed from the −y-axis direction, in which the third housing 230 of the foldable electronic device 200 is first folded toward the second housing 220, and then the first housing 210 is folded toward the second housing 220 so that the first housing 210 is placed on top of the third housing 230 (e.g., in the z-axis direction). For example, the foldable electronic device 200 disclosed in FIGS. 3A and 3B may include a multi-foldable electronic device that folds into a G-type shape. According to various embodiments, the foldable electronic device 200 may be folded into various shapes, such as a Z-type or an e-type, in addition to the G-type shape.

Referring to FIGS. 3A and 3B, the foldable electronic device 200 (e.g., a multi-foldable electronic device) may include a first housing 210, a second housing 220, a third housing 230, a first hinge module 201, a first hinge cover 201c, a second hinge module 202, and/or a second hinge cover 202c.

According to an embodiment, the third housing 230 may be first folded onto the top (e.g., in the z-axis direction) of the second housing 220 via the second hinge module 202 (e.g., a second in-folding hinge).

According to an embodiment, after the third housing 230 is folded relative to the second housing 220 via the second hinge module 202, the first housing 210 may be folded toward the second housing 220 via the first hinge module 201 (e.g., a first in-folding hinge) so as to be disposed on top (e.g., in the z-axis direction) of the third housing 230.

According to an embodiment, the first hinge module 201 may have a first width. The second hinge module 202 may have a second width. For example, the first width may be greater than the second width. According to various embodiments, since the third housing 230 is folded first relative to the second housing 220, and the first housing 210 is subsequently folded relative to the second housing 220 so that the first housing 210 is disposed on top (e.g., in the z-axis direction) of the third housing 230, the first width of the first hinge module 201 may be configured to be greater than the second width of the second hinge module 202. For example, the first hinge module 201 may include a first in-folding hinge, a wide hinge, or a big hinge that has a greater width than the second hinge module 202. For example, the second hinge module 202 may include a second in-folding hinge, a slim hinge, or a small hinge that has a smaller width than the first hinge module 201. In an embodiment, the first hinge module 201 may have a larger radius of curvature than the second hinge module 202. The second hinge module 202 may have a smaller radius of curvature than the first hinge module 201.

According to an embodiment, a first hinge cover 201c (e.g., a first hinge housing) may be disposed between the first housing 210 and the second housing 220. The first hinge cover 201c may be disposed to cover at least a portion of the first hinge module 201. The first hinge cover 201c may be covered by at least a portion of the first housing 210 and the second housing 220, or visually exposed to the outside depending on whether the first housing 210 and the second housing 220 are in the unfolded or folded state. For example, when the first housing 210 and the second housing 220 are in the unfolded state, at least a portion of the first hinge module 201 may be covered by the first housing 210 and the second housing 220 and may not be substantially exposed. For example, when the first housing 210 and the second housing 220 are in the folded state, at least a portion of the first hinge cover 201c may be visually exposed to the outside between the first housing 210 and the second housing 220. The first hinge cover 201c may at least partially include a curved surface. The first hinge cover 201c may be formed of a conductive material (e.g., metal) and/or a non-conductive material (e.g., polymer).

According to an embodiment, a second hinge cover 202c (e.g., a second hinge housing) may be disposed between the second housing 220 and the third housing 230. The second hinge cover 202c may be disposed to cover at least a portion of the second hinge module 202. The second hinge cover 202c may be partially covered or partially exposed by at least a portion of the second housing 220 and the third housing 230 depending on whether the second housing 220 and the third housing 230 are in the unfolded or folded state. For example, when the second housing 220 and the third housing 230 are in the unfolded state, the second hinge cover 202c may be partially covered or partially exposed by the second housing 220 and the third housing 230. For example, when the second housing 220 and the third housing 230 are in the folded state, at least a portion of the second hinge cover 202c may be visually exposed to the outside between the second housing 220 and the third housing 230, The second hinge cover 202c may at least partially include a curved surface. The second hinge cover 202c may be formed of a conductive material (e.g., metal) and/or a non-conductive material (e.g., polymer).

According to various embodiments, the width of the first hinge cover 201c may be configured to be greater than the width of the second hinge cover 202c. For example, since the first width of the first hinge module 201 is greater than the second width of the second hinge module 202, the width of the first hinge cover 201c may be configured to be greater than the width of the second hinge cover 202c.

According to various embodiments, the foldable electronic device 200 (e.g., a multi-foldable electronic device) disclosed below may include at least some of the embodiments described with reference to FIGS. 1, 2A, 2B, 3A, and 3B. Embodiments related to the foldable electronic device 200 disclosed below may be integrated and applied to, for example, the embodiments of the foldable electronic device 200 disclosed with reference to FIGS. 2A, 2B, 3A, and 3B. In the description of a foldable electronic device 200 according to various embodiments of the disclosure disclosed below, substantially identical components as those in the embodiments disclosed in FIGS. 1, 2A, 2B, 3A, and 3B will be assigned the same reference numerals, and redundant descriptions of their functions will be omitted.

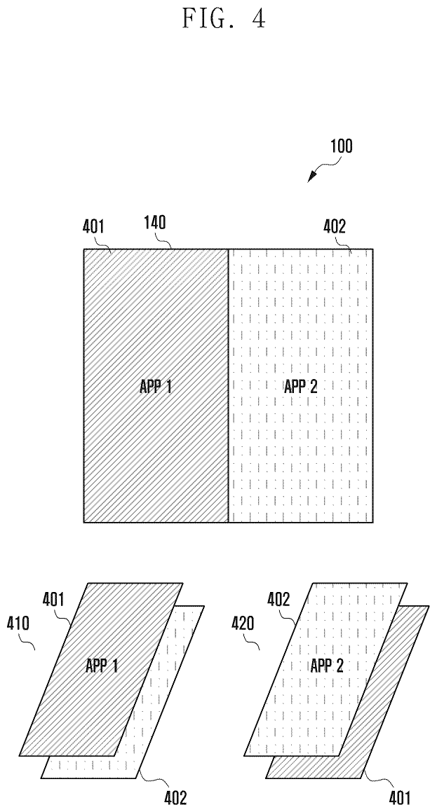

FIG. 4 is a diagram illustrating a situation in which an electronic device executes a plurality of applications according to an embodiment of the disclosure.

An electronic device 100 may be used by a plurality of users including a host and a guest. For example, the electronic device 100 may execute a plurality of applications. The plurality of applications may include applications executed by different users (e.g., a host and a guest). The host may refer to a user who is the owner and/or administrator of the electronic device 100 and has a variety of authority to control the electronic device 100. The host may control the electronic device 100 to grant users other than the host the authority to use the electronic device 100. The guest may refer to a user who is granted the authority to use the electronic device by the host.

The electronic device 100 may grant the authority to control the electronic device 100 only to the host. A state in which the authority to control the electronic device 100 is granted only to the host may be referred to as host mode. The electronic device 100 may grant at least some of the authority to control the electronic device 100 to users (e.g., guests) other than the host. A state in which at least some of the authority to control the electronic device 100 is granted to users other than the host may be referred to as guest mode. At least some of the authority to control the electronic device 100 may include authority to execute various functions, including authority to execute applications of the electronic device 100 and/or authority to manage information generated by the execution of applications. The electronic device 100 may switch (or determine to switch) the state (or mode) of the electronic device 100 from one of the guest mode and the host mode to the other based on user input or when predetermined conditions are met.

In the case where at least some of the authority to control the electronic device 100 is also granted to a guest (e.g., guest mode), the electronic device 100 may execute a plurality of applications simultaneously. For example, the electronic device 100 may execute a first application 401 and a second application 402 simultaneously. When executing the first application 401 and the second application 402 simultaneously, the electronic device 100 may execute one application in the foreground and the remaining application in the background. For example, when a most recent user input is received for the first application 401 (410), the processor may execute the first application 401 in the foreground and the second application 402 in the background (410). When a user input is received for the second application 402 running in the background (420), the processor may execute the second application 402 in the foreground and execute the first application 401, which was running in the foreground, in the background (420). According to an embodiment, the electronic device 100 may execute a plurality of applications even when only the host is authorized to control the electronic device 100.

When the electronic device 100 is in the guest mode, which allows both the host and guest to use it, a plurality of user inputs may be received by the display 140. The plurality of user inputs may include user inputs provided by the host and/or the guest. The electronic device 100 may switch the states (e.g., foreground and background) of the plurality of applications according to the plurality of user inputs. The host and guest may experience inconvenience due to frequent state transitions of the plurality of applications. For example, the plurality of users may experience delays resulting from repeated reallocation of system resources as the foreground and background states are repeatedly switched. The electronic device 100 of the disclosure may address the aforementioned issues by processing events for each of the plurality of applications through different modules when executing the plurality of applications in the foreground.

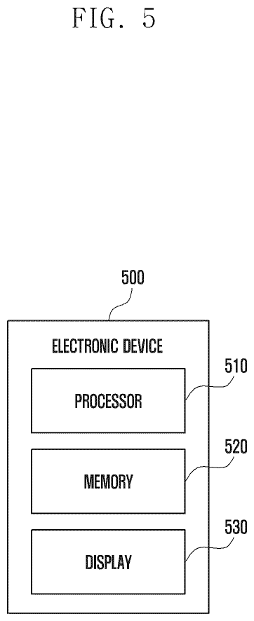

FIG. 5 is a block diagram of an electronic device according to an embodiment of the disclosure.

An electronic device 500 (e.g., the electronic device 100 in FIG. 1 or the foldable electronic device 200 in FIGS. 2A and 2B) may include a processor 510 (e.g., the processor 110 in FIG. 1), a memory 520 (e.g., the memory 120 in FIG. 1), and/or a display 530 (e.g., the display 140 in FIG. 1 or the flexible display 240 in FIG. 2A).

The memory 520 (e.g., the memory 120 in FIG. 1) may store various types of applications supported by the electronic device 500. For example, applications stored in the memory 520 may include various system applications (e.g., programs for device management, settings, file navigation, and home screen management) running in the operating system, as well as user applications including a message application, a call application, and a photo application. Each of the plurality of applications may be executed by the processor 510 (e.g., the processor 110 in FIG. 1) under the control of the operating system.

The application may be executed in the foreground or in the background. The execution screen of the application running in the foreground may be displayed on the display 530 (e.g., the display 140 in FIG. 1). When a user input is received on the execution screen of the application running in the foreground, the processor 510 may process an event for the application corresponding to the user input. The application running in the foreground may be allocated system resources at a higher priority than the application running in the background. The application running in the background may be allocated system resources at a lower priority than the application running in the foreground, but this does not mean that the application is not allocated system resources. The execution screen of the application running in the background may be displayed on the display 530, but may not receive a user input. However, when a user input is received on the execution screen of an application running in the background, the processor 510 may switch the application running in the background to the foreground and process an event for the application, which was running in the background, corresponding to the user input.

The processor 510 may simultaneously execute a plurality of applications. The plurality of applications may include applications executed by different users (e.g., a host and a guest). The host may refer to a user who is the owner and/or administrator of the electronic device 500 and has a variety of authority to control the electronic device 500. The host may control the electronic device 500 to grant users other than the host the authority to use the electronic device 500. The guest may refer to a user who is granted the authority to use the electronic device 500 by the host. The electronic device 500 may provide some of a variety of authority to control the electronic device 500 to the guest. For example, the electronic device 500 may grant the authority to control the electronic device 500 only to the host. A state in which the authority to control the electronic device 500 is granted only to the host may be referred to as host mode. The electronic device 500 may grant at least some of the authority to control the electronic device 500 to users (e.g., guests) other than the host. A state in which at least some of the authority to control the electronic device 500 is granted to users (e.g., guests) other than the host may be referred to as guest mode. At least some of the authority to control the electronic device 500 may include authority to execute various functions, including authority to execute applications of the electronic device 500 and/or authority to manage information generated by the execution of applications. The electronic device 500 may switch (or determine to switch) the mode of the electronic device from one of the guest mode and the host mode to the other, based on user input or when predetermined conditions are met.

In the state (e.g., guest mode) in which at least some of the authority to control the electronic device 100 is granted to the host and guest, the processor 510 may execute a plurality of applications simultaneously. When executing a plurality of applications simultaneously, the processor 510 may execute one application in the foreground and the remaining applications in the background. For example, the processor 510 may execute the application that most recently received a user input (e.g., touch input) in the foreground and execute the remaining applications in the background. When a user input is received for the application running in the background, the processor 510 may execute the application, which was running in the background, in the foreground and execute the application, which was running in the foreground, in the background. However, the processor 510 may also execute the plurality of applications in the foreground. The execution screens of the respective applications running in the foreground may be displayed on the display 530. When a user input is received on the execution screen of each of the plurality of applications, the processor 510 may identify the application corresponding to the user input and process the user input as an event for the identified application. According to an embodiment, the electronic device 500 (or processor 510) may simultaneously execute a plurality of applications (in the foreground) even in the host mode.

When a predetermined first user input is received, the processor 510 may determine to execute guest mode. In the disclosure, executing guest mode may include switching from host mode to guest mode. Executing host mode may include switching from guest mode to host mode. Guest mode may be a mode configured to allow a plurality of users (e.g., a host and a guest) to use the electronic device 500. The predetermined first user input may refer to a user input that instructs execution of various guest modes. For example, the predetermined first user input may include a user input for changing settings of the electronic device 500 to execute the guest mode and/or a user input that instructs a predetermined application to be executed in the guest mode.

According to an embodiment, the electronic device 500 may be a foldable electronic device 500 including a housing including a plurality of housing portions (e.g., the first housing 210, the second housing 220, and the third housing 230 in FIG. 2A), one or more hinges (e.g., the first hinge module 201 and the second hinge module 202 in FIG. 2A) connecting the plurality of housing portions, and/or at least one hinge sensor for measuring a folding angle of each of the one or more hinges. The folding angle of the hinge may refer to an angle between two housing portions connected by the hinge.

In the foldable electronic device 500, the processor 510 may detect a change in the folding angle of each of one or more hinges through at least one hinge sensor. The processor 510 may detect that the housing is in a predetermined folding state, based on the folding angle of each of the one or more hinges. If the housing is detected to be in a predetermined folding state, the processor 510 may determine to execute guest mode. The predetermined folding state may refer to a state of the housing in which the angle of each of the one or more hinges falls within a predetermined range. The predetermined folding state may be configured or changed by the manufacturer or user of the electronic device 500. According to one example, the predetermined folding state may refer to a folding state in which some of the display areas included in the display 530 are disposed in a different direction from other display areas. For example, if the angle between a first housing portion (e.g., the first housing 210 in FIG. 2A) and a second housing portion (e.g., the second housing 220 in FIG. 2A) is greater than or equal to 90 degrees and less than 180 degrees, and the angle between the second housing portion 220 and a third housing portion (e.g., the third housing 230 in FIG. 2A) is greater than or equal to 180 degrees, a first display area (e.g., the first display area 240a in FIG. 2A) disposed in the first housing portion 210 and a second display area (e.g., the second display area 240b in FIG. 2A) disposed in the second housing portion 220 may be included in a first part, and a third display area (e.g., the third display area 240c in FIG. 2A) disposed in the third housing portion 230 may be included in a second part. For example, if the angle between the second housing portion 220 and the third housing portion 230 is greater than or equal to 90 degrees and less than 180 degrees, and the angle between the first housing portion 210 and the second housing portion 220 is greater than or equal to 180 degrees, the first display area 240 a disposed in the first housing portion 210 may be included in the first part, and the second display area 240b included in the second housing portion 220 and the third display area 240c disposed in the third housing portion 230 may be included in the second part.

According to an embodiment, when a predetermined first user input is received or the housing is detected to be in a predetermined folding state, the processor 510 may identify whether the host consents to the execution of the guest mode. When the host consents to the execution of the guest mode, the processor 510 may determine to execute the guest mode.

If the processor 510 determines to execute the guest mode, the processor 510 may execute a plurality of applications in the foreground. For example, the processor 510 may execute a first application and a second application in the foreground. The first application may refer to an application used by the host. For example, the first application may be an application that was previously running in the foreground before the determination to execute the guest mode. The second application may refer to an application used by the guest, which begins running in the foreground upon the determination to execute the guest mode. For example, if the processor 510 determines to execute the guest mode while a message application is running in the foreground, the processor 510 may keep the first application in the foreground and further execute the second application in the foreground. The first application and the second application may be system applications as well as user applications. For example, the first application and the second application may be system applications for executing a home screen. It should be understood that determining to execute the guest mode (or host mode) of the disclosure may include initiating execution of the guest mode (or host mode).

The processor 510 may divide the display 530 into a plurality of parts including a first part and a second part. The processor 510 may display the execution screen of the first application in one of the first part or the second part, and display the execution screen of the second application in the other of the first part or the second part. If the processor 510 determines to execute the guest mode, the processor 510 may perform host authentication through the first part and/or the second part. Host authentication may refer to user authentication (e.g., pin, pattern, and password (PPP) authentication or face authentication) for the host. If the host authentication is successful, the processor 510 may display the execution screen of the first application on either the first part or the second part where the host authentication has been performed.

In the foldable electronic device 500, the processor 510 may divide the display 530 into a plurality of parts, including the first part and the second part, based on the state of the housing disposed in a predetermined folding state. The predetermined folding state may include a first folding state configured such that the first part includes the first display area (e.g., the first display area 240a in FIG. 2A) and the second display area (e.g., the second display area 240b in FIG. 2A) and the second part includes the third display area (e.g., the third display area 240c in FIG. 2A), and a second folding state configured such that the first part includes the first display area 240a and the second part includes the second display area 240b and the third display area 240c. When the processor 510 detects that the housing is in the first folding state, the processor 510 may allocate the first display area 240a and the second display area 240b to the first part, and allocate the third display area 240c to the second part. When the processor 510 detects that the housing is in the second folding state, the processor 510 may allocate the first display area 240a to the first part and allocate the second display area 240b and the third display area 240c to the second part. The processor 510 may display a first execution screen of the first application on one of the first part or the second part, and display a second execution screen of the second application on the other of the first part or the second part.

While executing the host mode, the processor 510 may generate a first mapping table including information indicating coordinates on the display 530. The information indicating coordinates on the display 530 may be comprised of information indicating coordinates of a first axis of the display 530 and information indicating coordinates of a second axis perpendicular to the first axis. The maximum value of the first axis coordinates of the display 530 may correspond to the horizontal length of the display 530. The maximum value of the second axis coordinates of the display 530 may correspond to the vertical length of the display 530. Therefore, the information indicating coordinates on the display 530, included in the first mapping table, may correspond to the size of the display 530.

While executing host mode, the processor 510 may identify the location where user input was received using the first mapping table. The processor 510 may identify the first axis coordinates and the second axis coordinates on the display 530 corresponding to the location where the user input was received.

If the processor 510 determines to execute guest mode, the processor 510 may generate a second mapping table including information indicating coordinates on the first part and information indicating coordinates on the second part. The information indicating coordinates on the first part (or second part) may be comprised of information indicating coordinates of a first axis of the first part (or second part) and information indicating coordinates of a second axis perpendicular to the first axis. According to an embodiment, the operation of generating the mapping table (e.g., the first mapping table or the second mapping table) by the processor 510 may include an operation of identifying a predetermined mapping table stored in the memory 520.

In the foldable electronic device 500, when the housing is in the first folding state, the processor 510 may generate a second mapping table corresponding to the first folding state. For example, when the housing is in the first folding state, the first part may include the first display area (e.g., the first display area 240a in FIG. 2A) and the second display area (e.g., the second display area 240b in FIG. 2A), and the second part may include the third display area (e.g., the third display area 240c in FIG. 2A). The processor 510 may generate a second mapping table that includes information indicating coordinates on the first part including the first display area 240a and the second display area 240b, and information indicating coordinates on the second part including the third display area 240c. In addition, when the housing is in the second folding state, the processor 510 may generate a second mapping table corresponding to the second folding state. For example, when the housing is in the second folding state, the first part may include the first display area 240a and the second part may include the second display area 240b and the third display area 240c. The processor 510 may generate a second mapping table that includes information indicating coordinates on the first part including the first display area 240a, and information indicating coordinates on the second part including the second display area 240b and the third display area 240c. According to an embodiment, the memory 520 may store information indicating coordinates on the first display area 240a, information indicating coordinates on the second display area 240b, and/or information indicating coordinates on the third display area 240c. When the display 530 is divided into a plurality of parts including a first part and a second part, the processor 510 may generate information indicating coordinates of the first part and the second part using information indicating coordinates on the first display area 240a, information indicating coordinates on the second display area 240b, and/or information indicating coordinates on the third display area 240c.

While executing guest mode, the processor 510 may identify the location where a user input was received using the second mapping table. The processor 510 may identify whether the location where the user input was received belongs to the first part or the second part. If the location where the user input was received belongs to the first part (or the second part), the processor 510 may identify first axis coordinates and second axis coordinates on the first part (or the second part) corresponding to the location where the user input was received.

The processor 510, based on the location where the user input was received, may identify whether the user input is for the first application or the second application. If the location where the user input was received is included in the first part (or the second part), the processor 510 may identify that the user input is for the application corresponding to the execution screen displayed in the first part (or the second part). For example, when the first execution screen of the first application is displayed on the first part, the processor 510 may identify that the user input received in the first part is for the first application.

The processor 510 may process the user input as an event for the application corresponding to the user input. For example, if the user input is for the first application, the processor 510 may process the user input as an event for the first application.

According to an embodiment, the processor 510 may receive a user input for the first application and a user input for the second application substantially simultaneously. As the first application and the second application are executed in the foreground, the processor 510 may simultaneously receive a user input for the first application and a user input for the second application, or may sequentially receive a user input for the first application and a user input for the second application. When processing the user input for the first application and the user input for the second application as events for respective applications, the processor 510 may process the user input for the first application and the user input for the second application substantially simultaneously. Alternatively, the processor 510 may sequentially process the user input for the first application and the user input for the second application in a predetermined order. For example, the processor 510 may be pre-configured to preferentially process a user input for an application executed by the host of the electronic device 500.

When a predetermined second user input is received, the processor 510 may determine to terminate the guest mode. The predetermined second user input may refer to user input that instructs termination of various guest modes. For example, the second user input may include user input for changing settings of the electronic device 500 to terminate the guest mode.

In the foldable electronic device 500, the processor 510 may detect a change in the folding angle of each of one or more hinges (e.g., the first hinge module 201 and the second hinge module 202 in FIG. 2A) through at least one hinge sensor while the guest mode is running. The processor 510 may identify, based on the folding angle of each of one or more hinge modules 201 and 202, that the state of the housing does not substantially match a predetermined folding state. If the state of the housing does not substantially match a predetermined folding state, the processor 510 may determine to terminate the guest mode. The electronic device 500 may determine to terminate the guest mode if second conditions, including receiving a predetermined second user input and/or detecting a state of the housing that does not substantially match a predetermined folding state, are satisfied.

According to an embodiment, when the processor 510 receives a second user input or detects a state of the housing that does not substantially match a predetermined folding state, the processor 510 may determine whether the host consents to terminating the guest mode. If the host consents to terminating the guest mode, the processor 510 may determine to terminate the guest mode.

When the processor 510 determines to terminate the guest mode, the processor 510 may receive the host's consent regarding whether to store guest data. Guest data may refer to data related to the guest, which is generated during the execution of the guest mode. For example, the guest data may include data related to the second application, which is generated during the execution of the guest mode. If the host consents to storing the guest data, the processor 510 may store the guest data in a designated area of the memory 520. The processor 510 may store the guest data by mapping it to the guest authentication information of the guest. Storing the guest data by mapping it to the guest authentication information may refer to storing guest data as information associated with the guest authentication information such that the guest data is able to be accessed only when user authentication of the guest is successful. Through user authentication, the guest may continuously use guest data generated while the guest was using the electronic device 500. However, if the host does not consent to storing the guest data, the processor 510 may delete the guest data.

According to an embodiment, the processor 510 may also store the guest data in an area other than the designated area on the memory 520. For example, the processor 510 may store the guest data in an area of the memory 520 where host data is stored. The processor 510 may identify whether the host and guest consent to storing the guest data in the area of the memory 520 where the host data is stored. If both the host and guest consent to storing the guest data in the area of the memory 520 where the host data is stored, the processor 510 may store the guest data in the area of the memory 520 where the host data is stored. The processor 510 may establish a data channel connecting the area of the memory 520 where the host data is stored and a designated area of the memory 520 where the guest data is stored, so that the guest data is stored in the area of the memory 520 where the host data is stored.

When the processor 510 determines to terminate guest mode, the processor 510 may terminate the second application. When the processor 510 terminates the second application, the processor 510 may execute only the first application in the foreground.

When the processor 510 determines to terminate guest mode, the processor 510 may generate a first mapping table including information indicating coordinates on the display 530. The operation of generating a mapping table (e.g., the first mapping table or the second mapping table) by the processor 510 may include an operation of identifying a predetermined mapping table stored in the memory 520.

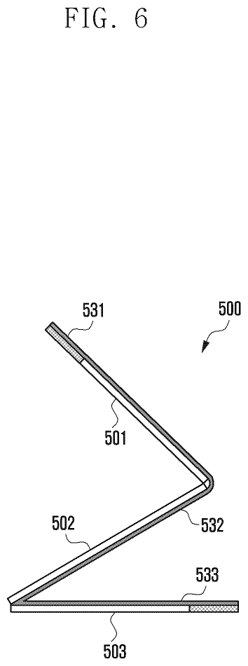

FIG. 6 is a diagram illustrating a foldable electronic device according to an embodiment of the disclosure.

An electronic device 500 (e.g., the electronic device 100 in FIG. 1 or the electronic device 200 in FIG. 2A) may be a foldable-type device comprised of three housing portions 501, 502, and 503 (e.g., the first housing 210, the second housing 220, and the third housing 230 in FIG. 2A). The electronic device 500 may include a housing including a first housing portion 501 (e.g., the first housing 210 in FIG. 2A), a second housing portion 502 (e.g., the second housing 220 in FIG. 2A), and a third housing portion 503 (e.g., the third housing 230 in FIG. 2A), which are foldable or movable relative to each other. The electronic device may include a first hinge module (not shown) (e.g., the first hinge module 201 in FIG. 2A) rotatably connected to the first housing portion 501 and the second housing portion 502, and a second hinge module (not shown) (the second hinge module 202 in FIG. 2A) rotatably connected to the second housing portion 502 and the third housing portion 503. According to an embodiment, the electronic device may include a printed circuit board (PCB) and/or at least one image sensor in one of the first housing portion 501, the third housing portion 503, or the second housing portion 502.

A display 530 (e.g., the display 140 in FIG. 1 or the flexible display 240 in FIG. 2A) included in the electronic device may be a flexible display. The flexible display may include a first display area 531 (e.g., the first display area 240a in FIG. 2A) disposed in the first housing portion 501, a second display area 532 (e.g., the second display area 240b in FIG. 2A) disposed in the second housing portion 502, and a third display area 533 (e.g., the third display area 240c in FIG. 2A) disposed in the third housing portion 503.

According to an embodiment, the electronic device 500 may be folded in a Z-type folding manner. When the electronic device 500 is folded in a Z-type folding manner, the first housing portion 501 and the second housing portion 502 may be folded relative to each other in an out-folding manner. When the first housing portion 501 and the second housing portion 502 are folded relative to each other in an out-folding manner, the first display area 531 disposed in the first housing portion 501 may be exposed to the outside. When the electronic device is folded in a Z-type folding manner, the third housing portion 503 and the second housing portion 502 may be folded relative to each other in an in-folding manner. When the third housing portion 503 and the second housing portion 502 are folded relative to each other in an in-folding manner, the third display area 533 disposed in the third housing portion 503 and the second display area 532 disposed in the second housing portion 502 may be folded to face each other. However, the electronic device 500 may also be folded in a folding manner (e.g., an e-type folding manner or a G-type folding manner) other than the Z-type. When the electronic device is folded in a folding manner other than the Z-type, the first housing portion 501 and the second housing portion 502 may be folded relative to each other in an in-folding manner, and the third housing portion 503 and the second housing portion 502 may be folded relative to each other in an out-folding manner.

The display areas (the first display area 531, the second display area 532, and the third display area 533) included in the display 530 may be disposed in various ways depending on the state of the housing. For example, the display areas (the first display area 531, the second display area 532, and the third display area 533) included in the display 530 may be disposed to facilitate viewing of different display areas by a plurality of users. When the housing is in a predetermined folding state, the electronic device 500 may determine to execute guest mode so that a plurality of users can use an application simultaneously. When the electronic device 500 determines to execute guest mode, the electronic device 500 may execute a plurality of applications in the foreground.

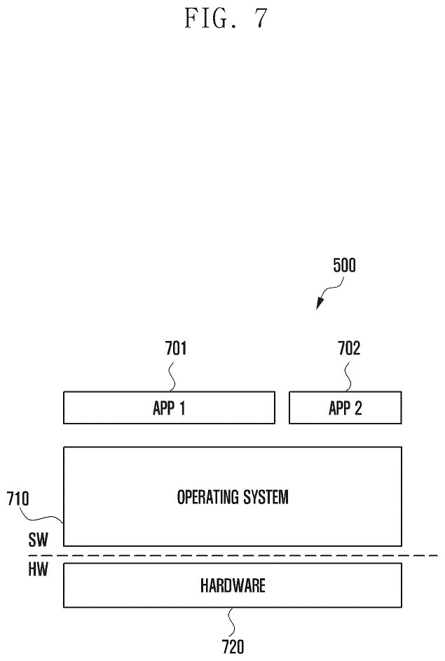

FIG. 7 is a block diagram of an electronic device according to an embodiment of the disclosure.

The electronic device 500 may include one or more applications (e.g., a first application 701 and a second application 702), an operating system 710, and/or hardware 720. The hardware 720 may include at least one of the components included in the electronic device 100 in FIG. 1 and/or the components of the electronic device 500 in FIG. 5. A display (e.g., the display 530 in FIG. 5 or the display 140 in FIG. 1) included in the hardware 720 may include a touch screen panel (TSP) that recognizes user touch input and a display panel that displays graphic objects. The TSP may recognize user touch input to the display panel. The display may be divided into a plurality of parts including a first part and a second part. The foldable electronic device 500 may include a display 530 including a first display area 531, a second display area 532, and/or a third display area 533.

The operating system 710 may perform some of the operations of the processor 510 in FIG. 5 by controlling the processor 510 in FIG. 5. The operations of the processor 510 described in FIG. 5 may be operations of the processor 510 performed under the control of the operating system 710. The operating system 710 may identify a user input received through the touch screen panel (TSP) included in the display 530 included in the hardware 720 and instructing the execution of an application. When a user input instructing the execution of an application (e.g., the first application 701 or the second application 702) is identified, the operating system 710 may generate a process used to execute the application. The operating system 710 may identify the application's executable file stored in the memory 520 and allocate system resources required for the execution of the application to the generated process. The system resources may include at least one resource required for executing the application, including volatile or non-volatile memory resources, central processing unit (CPU) resources, input/output (I/O) resources, network resources, power resources, and/or sensor resources. The operating system 710 may execute the application (e.g., the first application 701 or the second application 702) using the resources allocated to the process.

The operating system 710 may execute one application (e.g., the first application 701) in the foreground while executing host mode. The operating system 710 may display the execution screen of the first application 701 on the display 530. The TSP included in the display 530 may identify a touch input to the display panel and transmit the touch input to the operating system 710. The operating system 710 may identify the location where the touch input was received and process the touch input as an event for the running application (e.g., the first application 701).

When the execution of guest mode is determined, the operating system 710 (or a component included in the operating system 710) may divide the display 530 into a plurality of parts including a first part and a second part. The operating system 710 may display the execution screen of the first application 701 in one of the first part and the second part, and display the execution screen of the second application 702 in the other of the first part and the second part. The operating system may execute both the first application 701 and the second application 702 in the foreground while executing the guest mode.

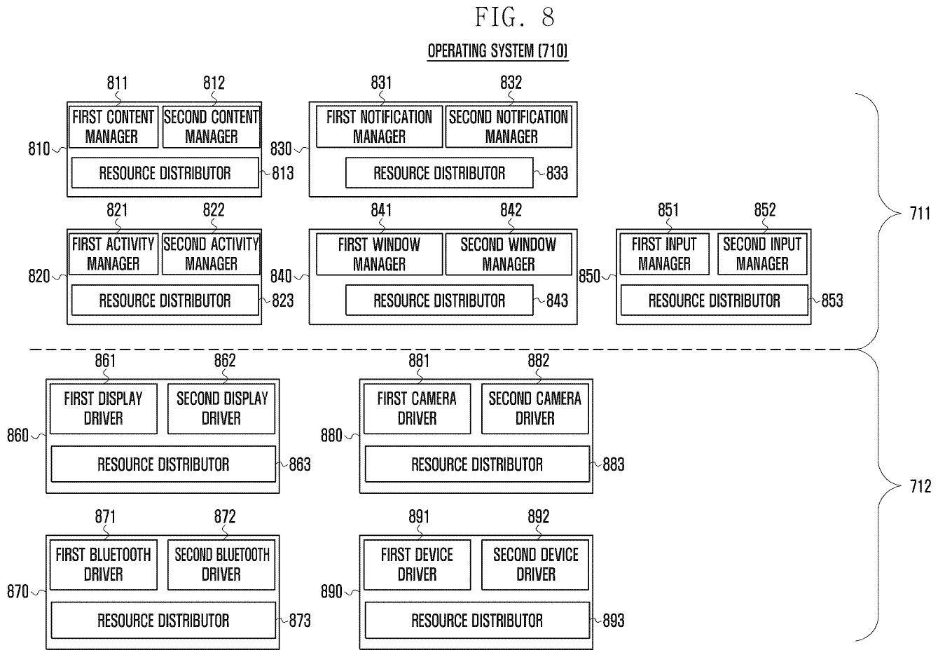

FIG. 8 is a diagram illustrating components included in an operating system according to an embodiment of the disclosure.

The operating system 710 may include a plurality of layers including a framework layer 711 and/or a kernel layer 712.

The framework layer 711 may include at least one manager (e.g., a content manager 810, an activity manager 820, a notification manager 830, a window manager 840, and/or an input manager 850) including a first event manager for processing events of the first application 701, a second event manager for processing events of the second application 702, and a resource distributor for distributing events to one of the first event manager and the second event manager. For example, the content manager 810 may include a first content manager 811 that is a first event manager, a second content manager 812 that is a second event manager, and a resource distributor 813 that distributes events to one of the first content manager 811 and the second content manager 812, and other managers (e.g., the activity manager 820, the notification manager 830, the window manager 840, and/or the input manager 850) included in the framework layer 711 may also have substantially the same structure.

The framework layer 711 may include a component (e.g., a manager) that manages the execution operation of an application (e.g., the first application 701 or the second application 702 in FIG. 7). The framework layer 711 may allocate hardware resources or system resources required during the execution of the application to the application through the content manager 810, activity manager 820, notification manager 830, window manager 840, and/or input manager 850.

The content manager 810 may manage an interface for sharing data with other applications. For example, the content manager 810 may abstract or standardize shared data. An application may transmit or receive data abstracted (or standardized) by the content manager 810 to or from other applications. The activity manager 820 may manage the execution status (e.g., running, paused, or terminated) of the application and may transmit user inputs transmitted through the input manager 850 to the application. The notification manager 830 may register notifications requested by the application. Registering notifications may include configuring the hardware to output the notifications. For example, the notification manager 830 may register notifications requested by the application in a status bar. The window manager 840 may manage windows included in the execution screen of the application. For example, the window manager 840 may manage the order of windows, the windows displayed on the display, and/or their layout. The input manager 850 may transmit user inputs to the application. According to one example, the input manager 850 may transmit user inputs to the application through the activity manager 820.

Each of the components (e.g., the content manager 810, the notification manager 830, the activity manager 820, the window manager 840, and the input manager 850) included in the framework layer 711 may include a first event manager (e.g., a first content manager (811), a first activity manager (821), a first notification manager (831), a first window manager (841), or a first input manager (851), a second event manager (e.g., second event manager (e.g., a second content manager (812), a second activity manager (822), a second notification manager (832), a second window manager (842), or a second input manager (852)), and a resource distributor (813, 823, 833, 843, 853). The first event manager may be active while in host mode and guest mode. The second event manager may be active in guest mode and inactive in host mode. The resource distributor may allocate events of applications to either the first event manager or the second event manager. The first event manager and the second event manager may perform operations corresponding to events allocated by the resource distributor. The first event manager may manage the execution operation of an application (e.g., the first application 701) executed by the host. The second event manager may manage the execution operation of an application (e.g., the second application 702) executed by the guest. The framework layer 711 may include components other than those illustrated in FIG. 8, and the components included in the framework layer 711 may include the first event manager, the second event manager, and the resource distributor.

For example, the resource distributor (813, 823, 833, 843, 853) may refer to a component that distributes (or delivers, transmits) an event received by each management unit (810, 820, 830, 840, 850) (or an event detected by the electronic device (500)) to one of the event managers included in each management unit (810, 820, 830, 840, 850), that is, a first event manager (e.g., a first content manager (811), a first activity manager (821), a first notification manager (831), a first window manager (841), or a first input manager (851)) for processing events of the first application (701), or a second event manager (e.g., a second content manager (812), a second activity manager (822), a second notification manager (832), a second window manager (842), or a second input manager (852)) for processing events of the second application (702).

For example, the resource distributor (813, 823, 833, 843, 853) may determine which application, among the first application (701) and the second application (702), corresponds to the event received by each management unit (810, 820, 830, 840, 850) (or detected by the electronic device (500)). If the event received by the management unit (810, 820, 830, 840, 850) (or detected by the electronic device (500)) corresponds to the first application (701), the resource distributor (813, 823, 833, 843, 853) may distribute the event to the first event manager (e.g., the first content manager (811), first activity manager (821), first notification manager (831), first window manager (841), or first input manager (851)). If the event received by the management unit (810, 820, 830, 840, 850) (or detected by the electronic device (500)) corresponds to the second application (702), the resource distributor (813, 823, 833, 843, 853) may distribute the event to the second event manager (e.g., the second content manager (812), second activity manager (822), second notification manager (832), second window manager (842), or second input manager (852)).

The kernel layer 712 may include at least one driver (e.g., a display driver 860, a Bluetooth driver 870, a camera driver 880, and/or a device driver 890) including a first camera driver 881 that processes events of the first application 701, a second camera driver 882 that processes events of the second application 702, and a resource distributor 883 that distributes events to one of the first driver and the second driver. For example, the display driver 860 may include a first display driver 861, which is a first driver, a second display driver 862, which is a second driver, and a resource distributor 863 that distributes events to one of the first display driver 861 and the second display driver 862, and other drivers (e.g., the Bluetooth driver 870, the camera driver 880, and/or the device driver 890 including a first device driver 891 and a second device driver 892) included in the kernel layer 712 may also have substantially the same structure.

For example, the resource distributor (863, 873, 883, 893) may refer to a component that distributes (or delivers, transmits) an event received by each driving unit (810, 870, 880, 890) (or an event detected by the electronic device (500)) to one of the drivers included in each driving unit (810, 870, 880, 890), that is, a first driver (e.g., a first display driver (861), first Bluetooth driver (871), first camera driver (881), or first device driver (891)) for processing events of the first application (701), or a second driver (e.g., a second display driver (862), second Bluetooth driver (872), second camera driver (882), or second device driver (892)) for processing events of the second application (702).

For example, the resource distributor (863, 873, 883, 893) may determine which application, among the first application (701) and the second application (702), corresponds to the event received by each driving unit (810, 870, 880, 890) (or detected by the electronic device (500)). If the event received by the driving unit (810, 870, 880, 890) (or detected by the electronic device (500)) corresponds to the first application (701), the resource distributor (863, 873, 883, 893) may distribute the event to the first driver (e.g., the first display driver (861), first Bluetooth driver (871), first camera driver (881), or first device driver (891)). If the event received by the driving unit (810, 870, 880, 890) (or detected by the electronic device (500)) corresponds to the second application (702), the resource distributor (863, 873, 883, 893) may distribute the event to the second driver (e.g., the second display driver (862), second Bluetooth driver (872), second camera driver (882), or second device driver (892)).

The kernel layer 712 may include components (e.g., drivers) that provide an interface between the application and the hardware. Events generated in the hardware may be transmitted to the application through the interface on the kernel layer 712. Events generated in the application may be transmitted to the hardware through the interface on the kernel layer 712. The kernel layer 712 may include a display driver 860, a Bluetooth driver 870, a camera driver 880, and/or a device driver 890.

The display driver 860 may drive the display 530 in the hardware at the request of the application. For example, the display driver 860 may display, on the display, an execution screen (or graphic object) requested for display by the application. In addition, the display driver 860 may divide the area on the display into a plurality of areas including a first part and a second part. The Bluetooth driver 870 may manage an interface between the Bluetooth protocol stack and the hardware. For example, the Bluetooth driver 870 may manage Bluetooth connections and data transmission and reception between the electronic device and an external electronic device. The camera driver 880 may drive cameras in the hardware at the request of an application. For example, the camera driver 880 may control cameras to capture images or videos. The camera driver 880 may transmit the captured images or videos to the application. The device driver 890 may transmit user inputs received through an input device of the hardware to the application. For example, the device driver 890 may transmit user touch input received through the TSP to the application.

The components (e.g., the display driver 860, the camera driver 880, the Bluetooth driver 870, and the device driver 890) included in the kernel layer 712 may include a first driver, a second driver, and a resource distributor. When host mode is executed, the resource distributor may transmit events generated by the application to the first driver. The resource distributor may allocate events of applications to one of the first driver and the second driver. The first driver and the second driver may perform operations corresponding to the events allocated by the resource distributor. The first driver may be active while in both host mode and guest mode. The second driver may be active while in guest mode and inactive while in host mode. The first driver may support the interaction between an application (e.g., the first application 701) executed by the host and the hardware. The second driver may support the interaction between an application (e.g., the second application 702) executed by the guest and the hardware. The kernel layer 712 may include components (e.g., drivers) other than those illustrated in FIG. 8, and the components included in the kernel layer 712 may include a first driver, a second driver, and a resource distributor.

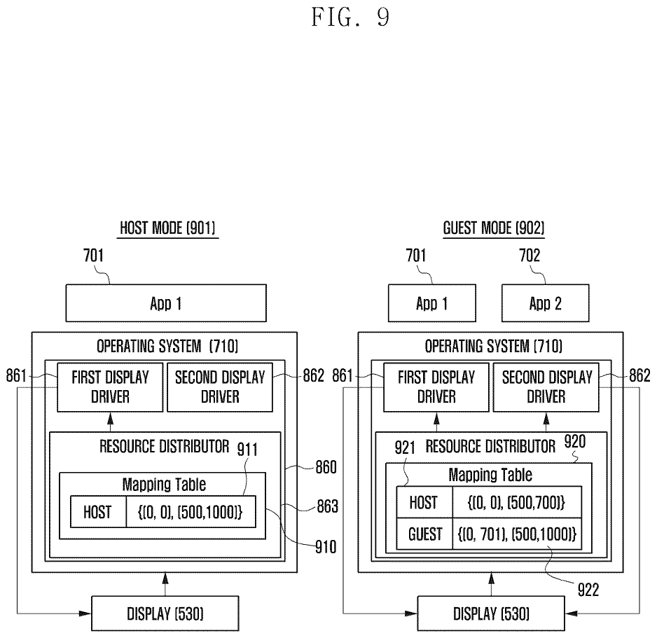

FIG. 9 is a diagram illustrating an operation of an operating system to output an application execution screen to a display in host mode or guest mode according to an embodiment of the disclosure.

A mapping table (e.g., a first mapping table 910 or a second mapping table 920) may be a table used to map the location where a user input (e.g., a host input or a guest input) is received to coordinates on the display 530. The mapping table may include information indicating coordinates on the display 530. When a user input is received, the electronic device 500 may identify the coordinates on the display 530 corresponding to the location where the user input was received through the mapping table.

While executing host mode 901, the resource distributor 863 of the display driver 860 may generate a first mapping table 910 including information indicating coordinates on the display 530. The information (e.g., (0,0) or (500,1000)) indicating coordinates on the display 530 may be comprised of information indicating coordinates of a first axis (e.g., (0-500)) of the display 530 and information (e.g., (0-1000)) indicating coordinates of a second axis perpendicular to the first axis. The maximum value of the first axis coordinates of the display 530 may correspond to the horizontal length of the display 530. The maximum value of the second axis coordinates of the display 530 may correspond to the vertical length of the display 530. Therefore, information indicating coordinates on the display 530 included in the first mapping table 910 may correspond to the size of the display 530.

The resource distributor 863 may transmit, to the first display driver 861, information indicating a portion allocated to the first application 701. The portion allocated to the first application 701 may refer to an area on the display 530 allocated to the first application 701 while the host mode 901 is running. For example, the portion allocated to the first application 701 may be the entire area included in the display 530. The portion allocated to the first application 701 may be recognized as the portion 911 allocated to the host in the first mapping table 910. The first display driver 861 may control the display 530 to display the execution screen of the first application 701 in the portion allocated to the first application 701.

When the execution of guest mode 902 is determined, the resource distributor 863 may divide the display 530 into a plurality of parts including a first part and a second part. The resource distributor 863 may allocate the first application 701 to one of the first part or the second part, and may allocate the second application 702 to the other of the first part or the second part. For example, in the foldable electronic device 500, the resource distributor 863 may divide the display 530 into a plurality of parts including a first part and a second part, based on the housing being in a predetermined folding state. The predetermined folding state may include a first folding state configured such that the first part includes a first display area 531 and a second display area 532 and the second part includes a third display area 533, and a second folding state configured such that the first part includes the first display area 531 and the second part includes the second display area 532 and the third display area 533. Upon detecting that the housing is in the first folding state, the resource distributor 863 may allocate the first display area 531 and the second display area 532 to the first part, and allocate the third display area 533 to the second part. When detecting that the housing is in the second folding state, the resource distributor 863 may allocate the first display area 531 to the first part and allocate the second display area 532 and the third display area 533 to the second part.

When the first application 701 and the second application 702 are allocated to the first part or the second part, respectively, the resource distributor 863 may generate a second mapping table 920 including information indicating coordinates on the first part and information indicating coordinates on the second part. The information indicating coordinates on the first part (or the second part) may be comprised of information indicating coordinates of a first axis of the first part (or second part) and information indicating coordinates of a second axis perpendicular to the first axis. According to an embodiment, the operation of generating the mapping table (e.g., the first mapping table 910 or the second mapping table 920) by the processor may include an operation of identifying a predetermined mapping table stored in the memory. The portion allocated to the first application 701 may be recognized as a portion allocated to the host 921 in the second mapping table 920. The portion allocated to the second application 702 may be recognized as a portion allocated to the guest 922 in the second mapping table 920.

The resource distributor 863 may transmit information indicating a portion where the first application 701 is displayed to the first display driver 861 and transmit information indicating a portion where the second application 702 is displayed to the second display driver 862. The portion where the first application 701 is displayed may refer to an area on the display 530 allocated to the first application 701 while the guest mode 902 is running. The portion where the second application 702 is displayed may refer to an area on the display 530 allocated to the second application 702 while the guest mode 902 is running. For example, if host authentication is performed through the first part, the portion where the first application 701 is displayed may be the first part, and the portion where the second application 702 is displayed may be the second part. The first display driver 861 may control the display 530 to display the execution screen of the second application 702 on the portion where the second application 702 is displayed. The second display driver 862 may control the display 530 to display the execution screen of the second application 702 on the portion where the second application 702 is displayed.

The operating system 710 may display the execution screen of the first application 701, which is running in the foreground, on the display 530 through the first display driver 861 while in host mode 901. The operating system, while in guest mode 902, may display the execution screen of the first application 701, which is running in the foreground, on the portion allocated to the first application 701 on the display 530 through the first display driver 861, and may display the execution screen of the second application 702, which is running in the foreground, on the portion allocated to the second application 702 on the display 530 through the second display driver 862. The operating system may allocate the first application 701 to a first driver (e.g., the first display driver 861) and the second application 702 to a second driver (e.g., the second display driver 862) through the resource distributor 863 included in a component (e.g., the display driver 860) of the kernel layer. The operating system may perform control of hardware (e.g., the display 530) required for the first application 701 through the first driver (e.g., the first display driver 861) and perform control of hardware (e.g., the display 530) required for the second application 702 through the second driver (e.g., the second display driver 862), thereby simultaneously maintaining two applications in the foreground.

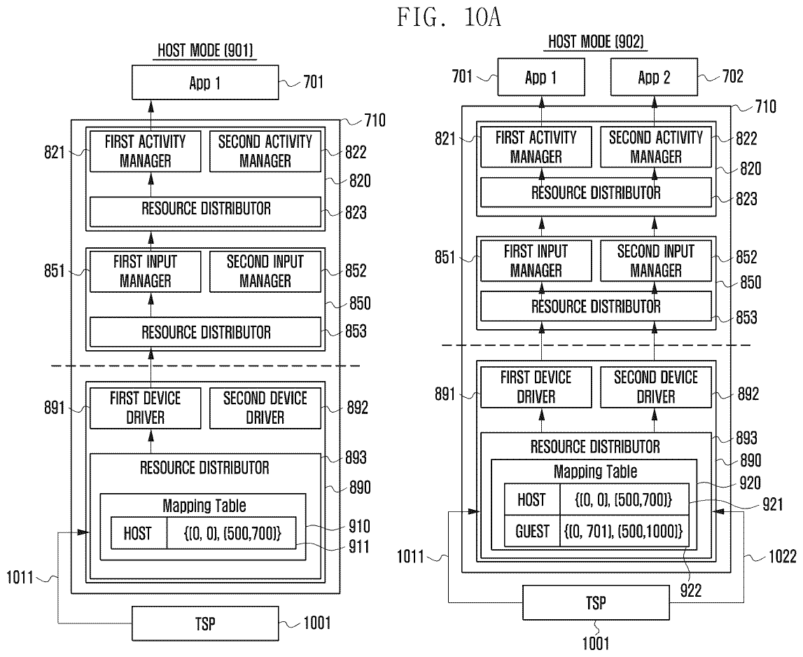

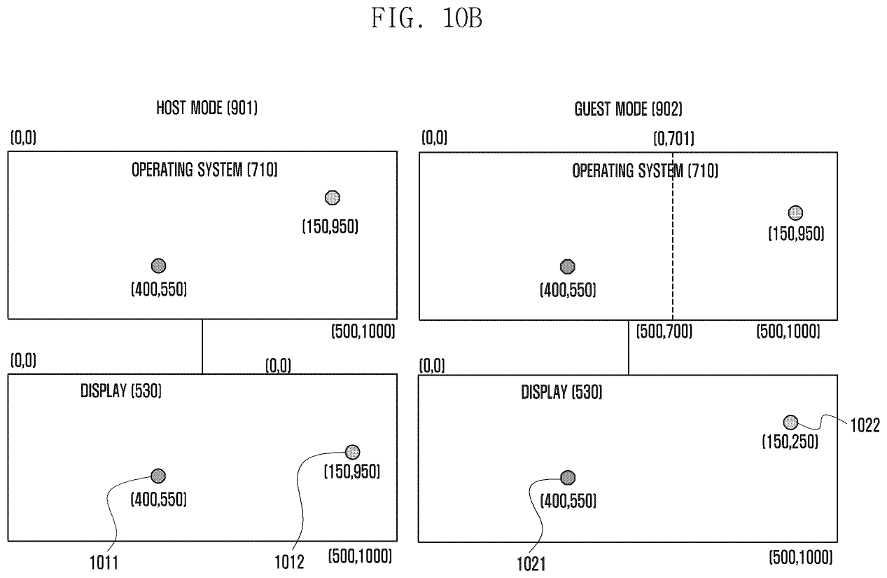

FIGS. 10A and 10B are diagrams illustrating an operation of an operating system to process user input in host mode or guest mode according to various embodiments of the disclosure.

The second device driver 892, the second input manager 852, and the second activity manager 822 included in the operating system 710 may be in an inactive state while in host mode 901. The operating system 710 may process a user input (e.g., touch input) through the first device driver 891, first input manager 851, and first activity manager 821, which are in an active state.

The TSP 1001 included in the display (e.g., the display 530 in FIG. 5) may identify a touch input on the display 530 and transmit it to the resource distributor 893 of the device driver 890.

The resource distributor 893 of the device driver 890, while in host mode 901, may identify the location where the touch input was received using the first mapping table 910. When the location where the touch input was received is included in the portion 911 allocated to the host in the first mapping table 910, the resource distributor 893 of the device driver 890 may identify that the touch input is an event to be processed by the first device driver 891. When the touch input is identified as an event to be processed by the first device driver 891, the resource distributor 893 of the device driver 890 may transmit the touch input to the first device driver 891. The first device driver 891 may transmit the touch input and information indicating the location where the touch input was received (e.g., the first and second axis coordinates on the display) to the resource distributor 853 of the input manager 850.

The resource distributor 853 of the input manager 850 may synchronize the first input manager 851 with the first device driver 891 when in host mode 901. Synchronizing the first input manager 851 with the first device driver 891 may include allowing the first input manager 851 to process touch input transmitted from the first device driver 891 to the input manager 850. Synchronization between the first input manager 851 and the first device driver 891 may be performed when switching from guest mode 902 to host mode 901 and may be maintained while in host mode 901. The resource distributor 853 of the input manager 850 may transmit the touch input and the information indicating the location where the touch input was received, which have been transmitted from the first device driver 891, to the first input manager 851. The first input manager 851 may transmit the touch input and the information indicating the location where the touch input was received to the resource distributor 823 of the activity manager 820.

In host mode 901, the resource distributor 823 of the activity manager 820 may transmit the touch input and the information indicating the location where the touch input was received, which have been transmitted from the first input manager 851, to the first activity manager 821. The first activity manager 821 may identify the application corresponding to the location where the touch input was received. For example, if the execution screen of the first application 701 is displayed at the location where the touch input was received, the first activity manager 821 may identify that the touch input is for the first application 701. The first activity manager 821 may transmit the touch input to the identified application (e.g., the first application 701).

The second device driver 892, the second input manager 852, and the second activity manager 822 included in the operating system 710 may be active while in guest mode 902. The operating system 710 may process a user input (e.g., touch input) of the host through the active first device driver 891, first input manager 851, and first activity manager 821. The operating system 710 may process a user input (e.g., touch input) of the guest through the active second device driver 892, second input manager 852, and second activity manager 822.

The resource distributor 893 of the device driver 890 may identify the location where the touch input was received using the second mapping table 920 while in guest mode 902. If the location where the touch input was received is included in the portion 921 allocated to the host in the second mapping table 920, the resource distributor of the device driver 890 may identify that the touch input is an event to be processed by the first device driver 891. When the touch input is identified as an event to be processed by the first device driver 891, the resource distributor 893 of the device driver 890 may transmit the touch input to the first device driver 891. The first device driver 891 may transmit the touch input and information indicating the location where the touch input was received (e.g., the first and second axis coordinates on the display) to the resource distributor 853 of the input manager 850.

When the location where the touch input was received is included in the portion 922 allocated to the guest in the second mapping table 920, the resource distributor 893 of the device driver 890 may identify that the touch input is an event to be processed by the second device driver 892. When the touch input is identified as an event to be processed by the second device driver 892, the resource distributor 893 of the device driver 890 may transmit the touch input to the second device driver 892. The second device driver 892 may transmit the touch input and information indicating the location where the touch input was received (e.g., the first and second axis coordinates on the display) to the resource distributor of the input manager 850.

While in guest mode 902, the resource distributor of the input manager 850 may synchronize the first input manager 851 with the first device driver 891 and synchronize the second input manager 852 with the second device driver 892. The resource distributor 853 of the input manager 850 may transmit the touch input and the information indicating the location where the touch input was received, which have been transmitted from the first device driver 891, to the first input manager 851, and transmit the touch input and the information indicating the location where the touch input was received, which have been transmitted from the second device driver 892, to the second input manager 852. The first input manager 851 and the second input manager 852 may transmit the touch input and the information indicating the location where the touch input was received to the resource distributor 823 of the activity manager 820.

The resource distributor 823 of the activity manager 820, while in guest mode 902, may transmit the touch input and the information indicating the location where the touch input was received, which have been transmitted from the first input manager 851, to the first activity manager 821, and transmit the touch input and the information indicating the location where the touch input was received, which have been transmitted from the second input manager 852, to the second activity manager 822. The first activity manager 821 or the second activity manager 822 may identify the application corresponding to the location where the touch input was received. For example, when the execution screen of the first application 701 is displayed at the location where the touch input was received, the first activity manager 821 may identify that the touch input is for the first application 701. The first activity manager 821 may transmit the touch input to the first application 701. When the execution screen of the second application 702 is displayed at the location where the touch input was received, the second activity manager 822 may identify that the touch input is for the second application 702. The second activity manager 822 may transmit the touch input to the second application 702.

The operating system 710, while in guest mode 902, may independently process user inputs input to two applications running in the foreground, respectively, through different components in the operating system 710. For example, the operating system 710 may process a user input to the first application 701 through the first device manager 891, the first input manager 851, and the first activity manager 821 as an event for the first application 701, and process a user input to the second application 702 through the second device manager 892, the second input manager 852, and the second activity manager 822 as an event for the second application 702.

Referring to FIG. 10B, the operating system 710 may execute the first application while executing the host mode. The operating system 710 may generate (or use) a first mapping table including information indicating coordinates on the display 530 while executing the host mode. The operating system 710 may receive touch inputs (e.g., a first touch input 1011 and a second touch input 1012) to the display 530 (or the TSP included in the display 530). The operating system 710 may identify whether the locations where the first touch input 1011 and second touch input 1012 were received are included in a portion allocated to the host (e.g., the portion 911 allocated to the host in FIG. 9) in the first mapping table 910. For example, when the location (e.g., (400, 550)) where the first touch input 1011 was received and/or the location (e.g., (150, 950)) where the second touch input 1012 was received is included in the portion 911 allocated to the host, the operating system 710 may process the first touch input 1011 and/or the second touch input 1012 as events for the first application 701.

The operating system 710 may execute the first application 701 and the second application 702 in the foreground while executing the guest mode. The operating system 710 may generate (or use) a second mapping table including information indicating coordinates on the first part and information indicating coordinates on the second part while executing the guest mode. The operating system 710 may receive touch inputs (e.g., a third touch input 1021 and a fourth touch input 1022) to the display 530 (or the TSP included in the display 530). The operating system 710, while executing the guest mode, may identify the locations where the touch inputs (e.g., the third touch input 1021 and the fourth touch input 1022) were received using the second mapping table. The operating system 710 may identify whether the location (e.g., (400, 550)) where the third touch input 1021 was received and/or the location (e.g., (150, 950)) where the fourth touch input 1022 was received are included in the portion 921 allocated to the host or the portion 922 allocated to the guest. When the location (e.g., (400, 550)) where the third touch input 1021 was received and/or the location (e.g., (150, 950)) where the fourth touch input 1022 was received are included in the portion 921 allocated to the host, the operating system 710 may process the third touch input 1021 and/or the fourth touch input 1022 as events for the first application. Alternatively, when the location (e.g., (400, 550)) where the third touch input 1021 was received and/or the location (e.g., (150, 950)) where the fourth touch input 1022 was received are included in the portion 922 allocated to the guest, the operating system 710 may process the third touch input 1021 and/or the fourth touch input 1022 as events for the second application.

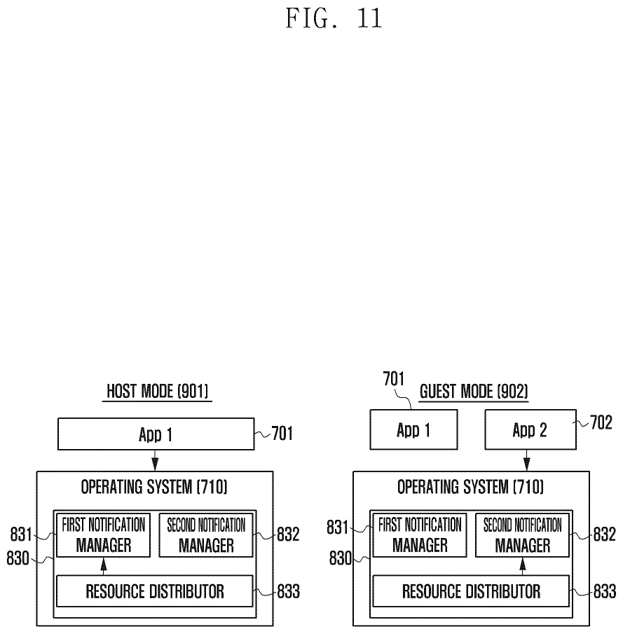

FIG. 11 is a diagram illustrating an operation of registering a notification by an operating system in host mode or guest mode according to an embodiment of the disclosure.

Events of the first application 701 and the second application 702 independently processed by the electronic device 500 may include events related to notifications. The application may register information indicating notifications to the operating system. The information indicating notifications may include a title of the notification, a body of the notification, an image (or icon) representing the notification, and/or an operation of the operating system corresponding to a user input for selecting the notification (e.g., executing an application corresponding to the selected notification). When the information indicating notifications is registered by the application, the operating system may generate and/or output a notification, based on the information indicating notifications. The operation of outputting a notification may include displaying the notification (or a window containing the notification) on the display or outputting a sound indicating the notification through a speaker.

The second notification manager 832 included in the operating system 710 may be inactive while in host mode 901. The operating system 710 may manage notifications registered by applications through the first notification manager 831 in an active state. When the information indicating notifications of the first application 701 running in the foreground is registered, the resource distributor 833 of the notification manager may transmit the registered information indicating notifications to the first notification manager 831. For example, if the location where the execution screen of the first application 701 is displayed is a portion allocated to the host in the first mapping table, the resource distributor 833 of the notification manager may transmit the information indicating notifications of the first application 701 to the first notification manager 831. Alternatively, the resource distributor 833 of the notification manager may identify an activity manager (e.g., the first activity manager 821) that manages the activities of the first application 701 and transmit the information indicating notifications of the first application 701 to a notification manager (e.g., the first notification manager 831) corresponding to the identified activity manager (e.g., the first activity manager 821). The notification manager (e.g., the first notification manager 831) corresponding to the identified activity manager (e.g., the first activity manager 821) may refer to a notification manager configured to manage applications executed by the same user (host or guest). The first notification manager 831 may generate a notification of the first application 701, based on the information indicating notifications.

The first notification manager 831 and the second notification manager 832 included in the operating system 710 may be in an active state while in guest mode 902. The operating system 710 may manage notifications registered by the applications through the first notification manager 831 and the second notification manager 832, which are in the active state. When the information indicating notifications of the first application 701 and/or second application 702 running in the foreground is registered, the resource distributor 833 of the notification manager may transmit the registered information indicating notifications to one of the first notification manager 831 or the second notification manager 832. For example, when the location where the execution screen of the first application 701 that has registered information indicating notifications is displayed is a portion allocated to the host in the second mapping table, the resource distributor 833 of the notification manager may transmit the information indicating notifications of the first application 701 to the first notification manager 831. When the location where the execution screen of the second application 702 that has registered information indicating notifications is displayed is a portion allocated to the guest in the second mapping table 920, the resource distributor 833 of the notification manager may transmit the information indicating notifications of the second application 702 to the second notification manager 832. Alternatively, the resource distributor 833 of the notification manager may identify an activity manager that manages activities of the application that has registered information indicating notifications, and transmit the information indicating notifications of the application to a notification manager corresponding to the identified activity manager. The first notification manager 831, based on the information indicating notifications of the first application 701, may generate a notification of the first application 701, and the second notification manager 832, based on the information indicating notifications of the second application 702, may generate a notification of the second application 702.

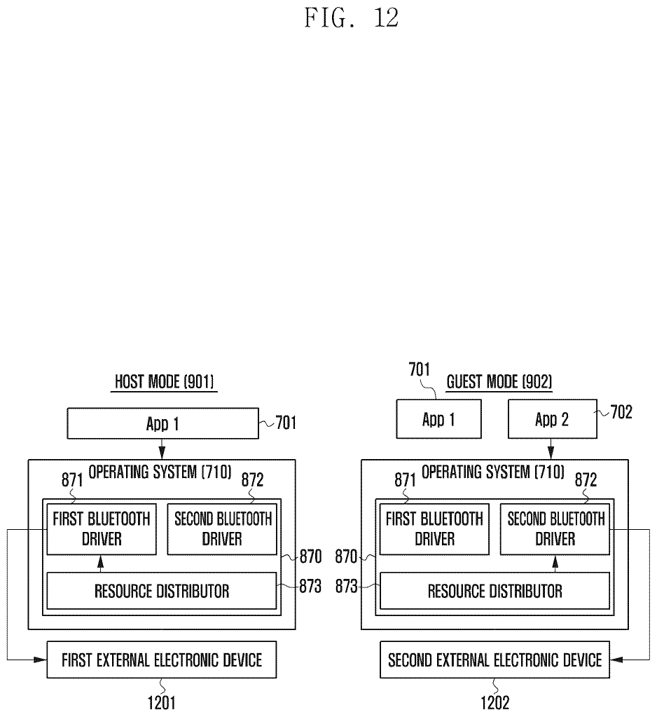

FIG. 12 is a diagram illustrating an operation of an operating system to process a Bluetooth connection request in host mode or guest mode according to an embodiment of the disclosure.

Events of the first application 701 and the second application 702 independently processed by the electronic device 500 may include events related to Bluetooth connections. An application (e.g., a system application (e.g., a program for device management, settings, file search, or home screen management)) may request the operating system 710 to establish a Bluetooth connection, based on a user input instructing a Bluetooth connection. The Bluetooth connection may include a wireless connection with external electronic devices (e.g., the first external electronic device 1201 and the second external electronic device 1202) performed through various communication methods, in addition to the Bluetooth connection.

The second Bluetooth driver 872 included in the operating system 710 may be inactive while in host mode 901. The operating system 710 may process a Bluetooth connection request from the first application 701 through the first Bluetooth driver 871 that is in an active state. For example, the first application 701 may request the operating system 710 to establish a Bluetooth connection in response to receiving a user input instructing a Bluetooth connection. The resource distributor 873 of the Bluetooth driver 870 included in the operating system 710 may identify the first application 701 that requested the Bluetooth connection and transmit the Bluetooth connection request to the first Bluetooth driver 871. For example, when the location where the execution screen of the first application 701 is displayed is a portion 911 allocated to the host in the first mapping table 910, the resource distributor 873 of the Bluetooth driver may transmit the Bluetooth connection request of the first application 701 to the first Bluetooth driver 871. The first Bluetooth driver 871 may perform a Bluetooth connection between the first external electronic device 1201 and the electronic device 500.

The first Bluetooth driver 871 and the second Bluetooth driver 872 included in the operating system 710 may be in an active state while in guest mode 902. The operating system 710 may process a Bluetooth connection request from an application through the first and second Bluetooth drivers that are in the active state. When a Bluetooth connection request is received from the first application 701 and/or the second application 702 running in the foreground, the resource distributor 873 of the Bluetooth driver may transmit the Bluetooth connection request to one of the first Bluetooth driver 871 or the second Bluetooth driver 872. For example, when the location where the execution screen of the first application 701 that requested the Bluetooth connection is displayed is a portion allocated to the host in the second mapping table, the resource distributor 873 of the Bluetooth driver transmit the Bluetooth connection request of the first application 701 to the first Bluetooth driver 871. When the location where the execution screen of the second application 702 that requested the Bluetooth connection is displayed is a portion allocated to the guest in the second mapping table, the resource distributor 873 of the notification driver may transmit the Bluetooth connection request of the second application 702 to the second Bluetooth driver 872. The second Bluetooth driver 872 may perform a Bluetooth connection between the second external electronic device 1202 and the electronic device 500 according to the Bluetooth connection request from the second application 702.

When determining to terminate the guest mode 902, the operating system 710 may receive the host's consent regarding whether to store a Bluetooth profile of the second external electronic device. If the host consents to storing the Bluetooth profile of the second external electronic device 1202, the operating system 710 may store the Bluetooth profile of the second external electronic device 1202 in a designated area on the memory 520 (e.g., a designated area on the memory 520 where the guest data is stored). However, if the host does not consent to storing the Bluetooth profile of the second external electronic device, the electronic device may delete the Bluetooth profile of the second external electronic device.

The designated area on the memory 520 where the guest's Bluetooth profile (e.g., the Bluetooth profile of the second external electronic device) is stored may be a separate area from the area where the host data is stored. The host may not be able to use the Bluetooth profile stored in the designated area on the memory 520 of the guest. Since the host is unable to use the profile of the second external electronic device 1202 stored in the designated area on the memory 520, the Bluetooth profile of the second external electronic device 1202 may need to be stored separately.

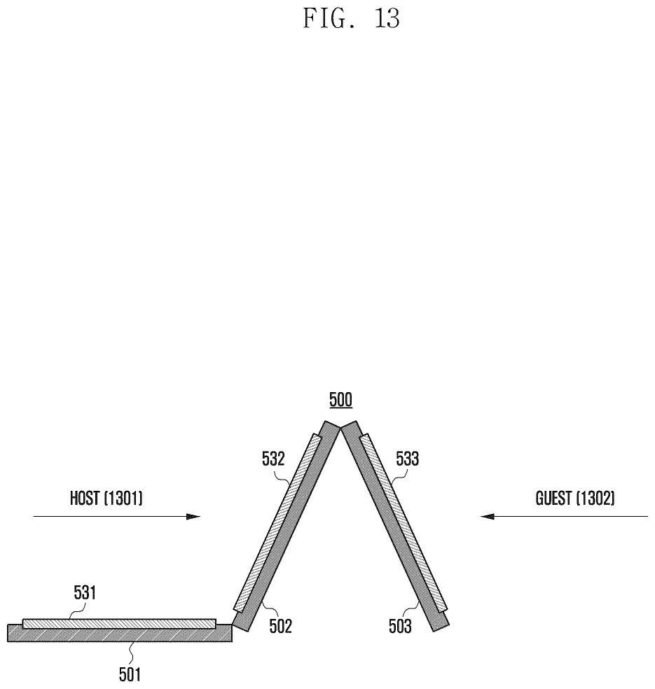

FIG. 13 is a diagram illustrating a folding state of a foldable electronic device according to an embodiment of the disclosure.

The electronic device 500 may be a foldable electronic device 500 that includes a housing including a first housing portion 501, a second housing portion 502, and a third housing portion 503, a first hinge connecting the first housing portion 501 and the second housing portion 502, a second hinge connecting the second housing portion 502 and the third housing portion 503, a first hinge sensor for measuring a folding angle of the first hinge, and/or a second hinge sensor for measuring a folding angle of the second hinge. The folding angle of the hinge may refer to an angle between two housing portions connected by the hinge.

The electronic device 500 may detect that the housing is in a predetermined folding state, based on the folding angle of the first hinge and the folding angle of the second hinge. When the housing is detected to be in a predetermined folding state, the electronic device 500 may determine to execute the guest mode 902. The predetermined folding state may refer to a state of a housing in which the folding angle of the first hinge and the folding angle of the second hinge each correspond to a predetermined range. The predetermined folding state may be configured or changed by the manufacturer or user of the electronic device 500. According to one example, the predetermined folding state may refer to a folding state in which some of the display areas included in the display are disposed in a different direction from other display areas.

According to an embodiment, even if the electronic device 500 does not detect the housing in the predetermined folding state, when a predetermined first user input is received, the electronic device 500 may determine to execute the guest mode 902. The guest mode 902 may refer to a mode configured to allow a plurality of users (e.g., a host 1301 and a guest 1302) to use the electronic device 500. The predetermined first user input may refer to a user input that instructs various guest modes to be executed. For example, the predetermined first user input may include a user input for changing settings of the electronic device 500 to execute the guest mode 902 and/or a user input that instructs a predetermined application to be executed in the guest mode 902. The electronic device 500 may determine to execute the guest mode 902 when first conditions, including receiving a predetermined first user input and/or detecting a predetermined folding state, are satisfied.

The electronic device 500 may divide the display 530 into a plurality of parts, including a first part and a second part, based on the housing that is in the predetermined folding state. The predetermined folding state may include a first folding state configured such that the first part includes a first display area 531 and a second display area 532 and the second part includes a third display area 533, and a second folding state configured such that the first part includes the first display area 531 and the second part includes the second display area 532 and the third display area 533. When detecting that the housing is in the first folding state, the electronic device 500 may allocate the first display area 531 and the second display area 532 to the first part, and allocate the third display area 533 to the second part. When detecting that the housing is in the second folding state, the electronic device 500 may allocate the first display area 531 to the first part and allocate the second display area 532 and the third display area 533 to the second part. The electronic device 500 may display the first execution screen of the first application 701 on one of the first part or the second part, and display the second execution screen of the second application 702 on the other of the first part or the second part. The first application 701 may be an application executed by the host 1301, and the second application 702 may be an application executed by the guest 1302.

Referring to FIG. 13, based on the housing being in the first folding state the electronic device 500 may allocate the first display area 531 and the second display area 532 to the first part and allocate the third display area 533 to the second part. If the electronic device 500 identifies that the user using the first part is the host 1301, the electronic device 500 may display the execution screen of the first application 701 on the first part and display the execution screen of the second application 702 on the second part. Although FIG. 13 illustrates the case where the user using the first part is the host 1301 and the user using the second part is the guest, it should be understood that the description of FIG. 13 may also be applied to the case where the user using the second part is the host 1301 and the user using the first part is the guest 1302. For example, even if the positions of the host 1301 and guest 1302 are swapped in FIG. 13, the electronic device 500 may identify whether the host is using the first part or the second part. In the case where the electronic device 500 identifies that the user using the second part is the host 1301, the electronic device 500 may display the execution screen of the second application 702 on the first part and display the execution screen of the first application 701 on the second part.

According to an embodiment, upon determining to execute the guest mode 902, the electronic device 500 may perform authentication of the host 1301 (e.g., various user authentication methods including pin, pattern, and password (PPP) and/or biometric authentication). The authentication of the host 1301 may be performed before or after the operation of dividing the display into a plurality of parts. The electronic device 500 may determine a part (e.g., the second part) that includes the display area (e.g., the third display area 533) where the authentication of the host 1301 was performed as an area where the first application 701 is displayed. The electronic device 500 may determine a part (e.g., the first part) that does not include the display area (e.g., the third display area 533) where the authentication of the host 1301 was performed as an area where the second application 702 is displayed.

User inputs from the host 1301 and user inputs from the guest 1302 may be processed separately in hardware and/or software. User inputs from the host 1301 may not be processed as an event for the application (e.g., the second application 702) executed by the guest 1302. User inputs from the guest 1302 may not be processed as an event for the application (e.g., the first application 701) executed by the host 1301.

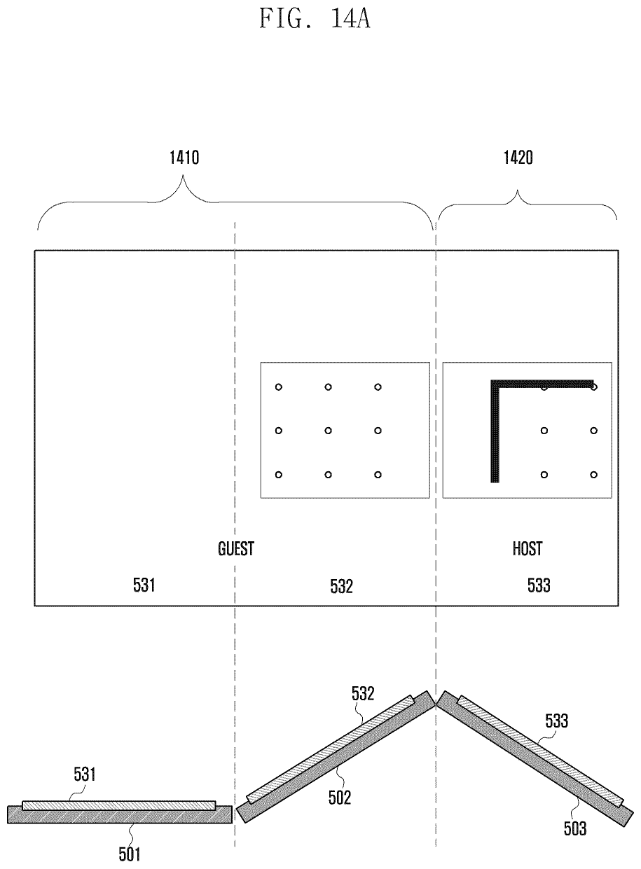

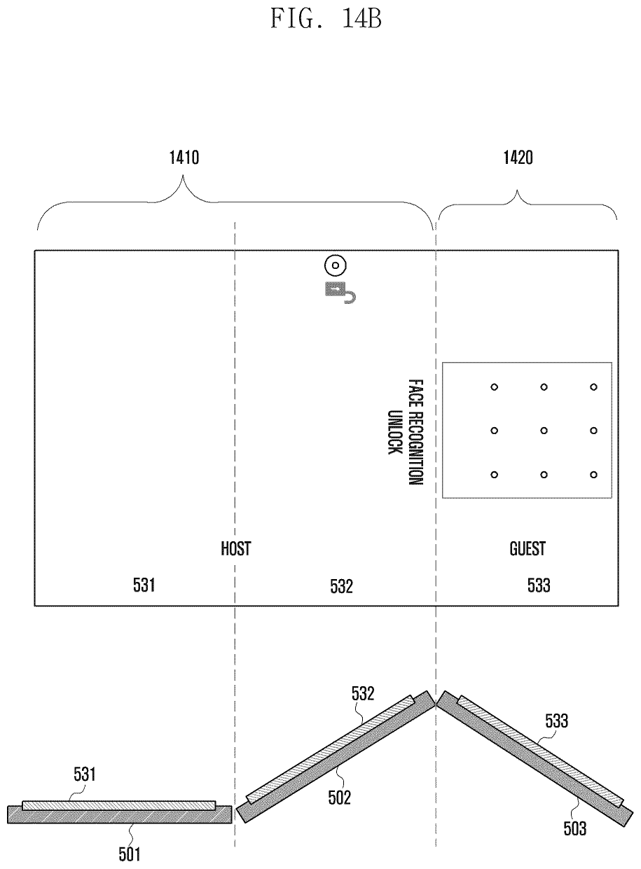

FIGS. 14A and 14B are diagrams illustrating a user authentication operation of an electronic device that has determined to execute guest mode according to various embodiments of the disclosure.

When the electronic device 500 divides the display 530 into a first part 1410 and a second part 1420 upon executing guest mode 902, the electronic device 500 may determine which of the first part 1410 or the second part 1420 corresponds to the host. The part corresponding to the host may be a part where the execution screen of an application (e.g., first application 701) executed by the host is displayed. The application executed by the host may be an application that was previously running before the guest mode is executed. The part corresponding to the host may be a part of the first part 1410 or the second part 1420 that includes a specific display area (e.g., a main display area). The electronic device 500 may determine a part of the first part 1410 or the second part 1420 that does not correspond to the host as a part corresponding to the guest. The part corresponding to the guest may be a part where the execution screen of an application (e.g., the second application 702) executed by the guest is displayed.

Upon determining to execute the guest mode 902, the electronic device 500 may perform authentication of the host (e.g., various user authentication methods including pin, pattern, and password (PPP) and/or biometric authentication) through at least one of the first part 1410 and the second part 1420.

Referring to FIG. 14A, the electronic device 500, based on the housing being in the first folding state, may determine the first display area 531 and the second display area 532 as the first part 1410 and determine the third display area 533 as the second part 1420. The electronic device 500 may determine the part (e.g., the second part 1420) that includes the display area (e.g., the third display area 533) where host authentication (e.g., pattern authentication) was performed as a part corresponding to the host. The electronic device 500 may determine a part (e.g., the first part 1410) that does not include the display area (e.g., the third display area 533) where the host authentication has been performed as a part corresponding to the guest.

Referring to FIG. 14B, the electronic device 500, based on the housing being in the first folding state, may determine the first display area 531 and the second display area 532 as the first part 1410 and the third display area 533 as the second part 1420. The electronic device 500 may determine a part (e.g., the first part 1410) that includes the display area (e.g., the second display area 532) where host authentication (e.g., face authentication) was performed as a part corresponding to the host. The electronic device 500 may determine a part (e.g., the second part 1420) that does not include the display area (e.g., the second display area 532) where the host authentication has been performed as a part corresponding to the guest.

If the host authentication is successful, the electronic device 500 may display an execution screen of the first application 701 on the part corresponding to the host. The electronic device 500 may display an execution screen of the second application 702 on the part corresponding to the guest. According to an embodiment, the electronic device 500 may perform guest authentication through the part corresponding to the guest. If the guest authentication is successful, the electronic device 500 may display the execution screen of the second application 702 on the part corresponding to the guest.

While executing guest mode 902, the electronic device 500 may obtain authentication information of the guest used to perform guest authentication. The authentication information of the guest may refer to guest information (e.g., biometric authentication information (e.g., fingerprint, face, or iris) or pin, pattern, and password (PPP)) used for the guest authentication. The authentication information of the guest may be managed by a component separate from the component of the operating system that manages authentication information of the host.

When storing guest data generated while executing the guest mode 902, the electronic device 500 may store the guest data by mapping it to the authentication information of the guest. Storing guest data by mapping it to the authentication information of the guest may refer to storing guest data as information associated with the guest authentication information such that the guest data is able to be accessed only when the guest authentication is successful. Through user authentication, the guest may continuously use guest data generated while the guest was previously using the electronic device 500. The electronic device 500 may store the guest data separately from host data. In addition, when storing guest data of a plurality of guests, the electronic device 500 may store the guest data of the plurality of guests in separate areas of the memory.

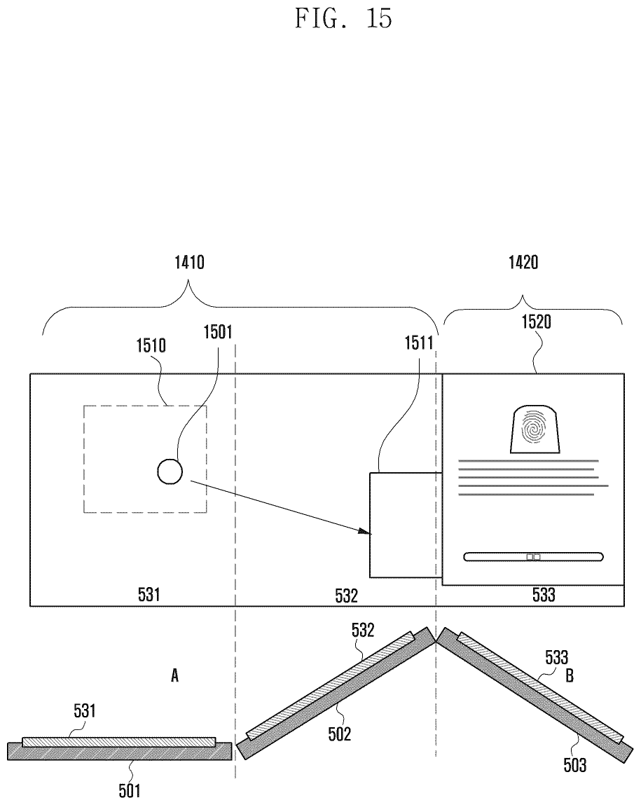

FIG. 15 is a diagram illustrating a method in which an electronic device executing guest mode processes user input according to an embodiment of the disclosure.

When the electronic device 500 divides the display into a first part 1410 and a second part 1420 upon executing guest mode, the electronic device 500 may determine which of the first part 1410 or the second part 1420 corresponds to the host. The case where the electronic device 500 determines the part corresponding to the host as the first part 1410 will be described in FIG. 15.

The electronic device 500 may process a host input to the first part 1410 separately from the second part 1420. The electronic device 500 may process a host input to the application (e.g., the first application 701) corresponding to the first part 1410 such that the host input does not affect the second part 1420.

According to an embodiment, the electronic device 500 may receive a specific host input through the first part 1410. The specific host input may be an input that instructs to move a graphic object 1511 from the first part 1410 to the second part 1420. For example, the specific host input may be an input 1501 of touching a graphic object 1510 displayed at a specific location 1510 of the first part 1410 and dragging it toward the second part 1420.

Even if a specific host input is received, the electronic device 500 may not move the graphic object to the second part 1420. The electronic device 500 may process a guest input to an execution surface 1520 of the application (e.g., the second application 702) corresponding to the second part 1420 as an event for an application (e.g., the second application 702) corresponding to the second part 1420.

The electronic device 500 may process user inputs generated in the first part 1410 and the second part 1420 separately from each other, thereby preventing the user input (e.g., host input) of the first part 1410 from affecting the application (e.g., the second application 702) displayed on the second part 1420. Although the above example shows the case where the user input (e.g., host input) of the first part 1410 does not affect the application (e.g., the second application 702) displayed on the second part 1420, it may be substantially equally applied to the case where the user input (e.g., guest input) of the second part 1420 does not affect the application (e.g., the first application 701) displayed on the first part 1410.

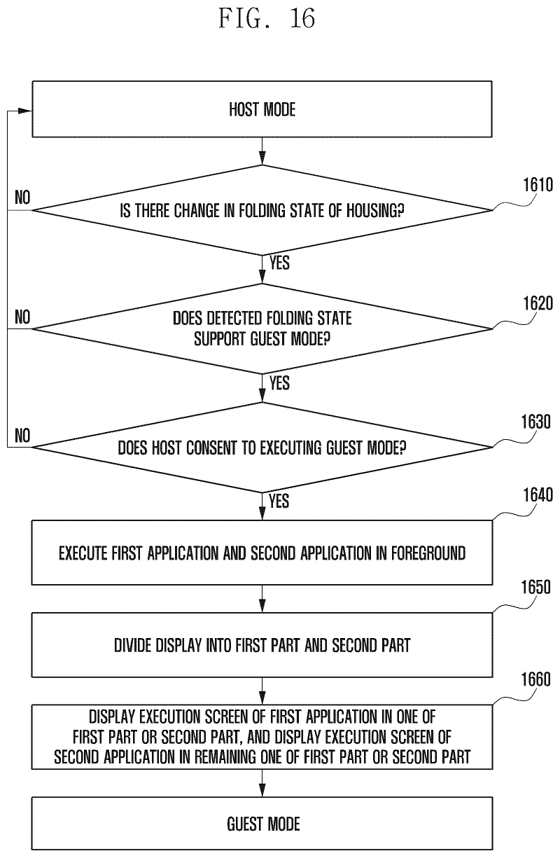

FIG. 16 is a flowchart illustrating an operation in which an electronic device executes guest mode while in host mode according to an embodiment of the disclosure.

In the following embodiments, respective operations may be performed sequentially, but are not necessarily performed sequentially. For example, the sequence of the respective operations may vary, and at least two operations may be performed in parallel.

Redundant description that has been made with reference to FIGS. 1, 2A, 2B, 3A, 3B, 4 to 9, 10A, 10B, 11 to 13, 14A, 14B, and 15 will be omitted from FIG. 16. The operations of the electronic device 500 in FIG. 16 may be executed by an electronic device 500 (e.g., the electronic device 100 in FIG. 1 or the electronic device 500 in FIG. 5), an operating system (e.g., the operating system 710 in FIG. 7), or a processor (e.g., the processor 110 in FIG. 1).

The electronic device 500 according to an embodiment may detect whether there is a change in the folding state of the housing in operation 1610.

According to an embodiment, the electronic device 500 may be a foldable electronic device 500 that includes a housing including a plurality of housing portions (e.g., the first housing portion 501, the second housing portion 502, and the third housing portion 503), one or more hinges connecting the plurality of housing portions, and at least one hinge sensor for measuring a folding angle of each of the one or more hinges. The folding angle of the hinge may refer to an angle between two housing portions connected by the hinge. The electronic device 500 may detect a change in the folding state of the housing by detecting a change in the folding angle of each of the one or more hinges through at least one hinge sensor.

According to an embodiment, when a change in the folding state of the housing is detected, the electronic device 500 may identify whether the detected folding state supports guest mode in operation 1620.

The electronic device 500 may detect that the housing is in a predetermined folding state that supports guest mode, based on the folding angle of each of the one or more hinges. When detecting that the housing is in the predetermined folding state, the electronic device 500 may determine to execute the guest mode (e.g., the guest mode 902 in FIG. 9). The predetermined folding state may refer to a folding state of the housing in which the angle of each of the one or more hinges falls within a p redetermined range. The predetermined folding state may be configured or changed by the manufacturer or user of the electronic device 500. According to one example, the predetermined folding state may refer to a folding state in which some of the display areas included in the display are disposed in a different direction from other display areas.

If the detected folding state supports guest mode, the electronic device 500 according to an embodiment may identify whether the host consents to executing guest mode in operation 1630.

If no change in the folding state of the housing is detected in operation 1610, if the detected folding state does not support guest mode in operation 1620, or if the host does not consent to executing guest mode, the electronic device 500 may execute host mode.

If the host consents to executing guest mode, the electronic device 500 according to an embodiment may execute a first application and a second application in the foreground in operation 1640. However, when a predetermined first user input is received, the electronic device 500 may skip operations 1610, 1620, and 1630 and perform operation 1640. The predetermined first user input may refer to a user input that instructs execution of various guest modes. For example, the predetermined first user input may include a user input for changing settings of the electronic device 500 to execute the guest mode and/or a user input that instructs a predetermined application to be executed in the guest mode.

When determining to execute guest mode, the electronic device 500 may execute a plurality of applications in the foreground. For example, the electronic device 500 may execute a first application and a second application in the foreground. The first application may refer to an application used by the host. For example, the first application may be an application that was previously running in the foreground before the determination to execute the guest mode. The second application may refer to an application used by the guest, which begins running in the foreground upon the determination to execute the guest mode. For example, if the electronic device 500 determines to execute the guest mode while a message application is running in the foreground, the electronic device 500 may keep the first application in the foreground and further execute the second application in the foreground. The first application and the second application may refer to user applications or system applications. For example, the first application and the second application may be system applications for executing a home screen.

The electronic device 500 according to an embodiment may divide the display into a first part and a second part in operation 1650.

In the foldable electronic device 500, the electronic device 500 may divide the display into a plurality of parts, including a first part (e.g., the first part 1410 in FIG. 14A) and a second part (e.g., the second part 1420 in FIG. 14A), based on the state of the housing disposed in a predetermined folding state. The predetermined folding state may include a first folding state configured such that the first part includes a first display area (e.g., the first display area 531 in FIG. 6) and a second display area (e.g., the second display area 532 in FIG. 6) and the second part includes a third display area (e.g., the third display area 533 in FIG. 6), and a second folding state configured such that the first part includes the first display area and the second part includes the second display area and the third display area. When the electronic device 500 detects that the housing is in the first folding state, the electronic device 500 may allocate the first display area and the second display area to the first part, and allocate the third display area to the second part. When the electronic device 500 detects that the housing is in the second folding state, the electronic device 500 may allocate the first display area to the first part and allocate the second display area and the third display area to the second part.

When the electronic device 500 determines to execute guest mode, the electronic device 500 may generate a second mapping table including information indicating coordinates on the first part and information indicating coordinates on the second part. The information indicating coordinates on the first part (or second part) may be comprised of information indicating coordinates of a first axis of the first part (or second part) and information indicating coordinates of a second axis perpendicular to the first axis.

The electronic device 500 according to an embodiment may display an execution screen of the first application in one of the first part or the second part, and display an execution screen of the second application in the other of the first part or the second part in operation 1660.

For example, the electronic device 500 may display the execution screen of the first application executed by the host on the part of the first part or the second part where host authentication has been performed. The electronic device 500 may display the execution screen of the second application executed by the guest on the part of the first part or the second part where host authentication has not been performed.

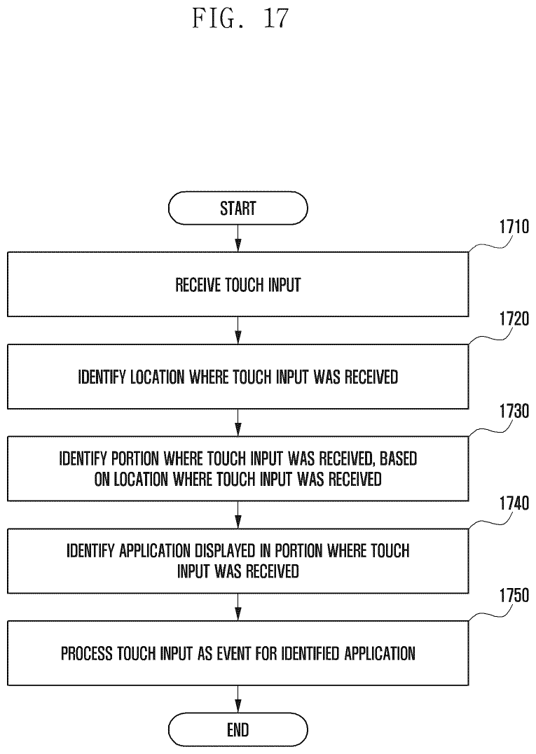

FIG. 17 is a flowchart illustrating an operation in which an electronic device processes touch input while in guest mode according to an embodiment of the disclosure.

In the following embodiment, respective operations may be performed sequentially, but are not necessarily performed sequentially. For example, the sequence of the respective operations may vary, and at least two operations may be performed in parallel.

Redundant description that has been made with reference to FIGS. 1, 2A, 2B, 3A, 3B, 4 to 9, 10A, 10B, 11 to 13, 14A, 14B, 15, and 16 will be omitted from FIG. 17. The operations of the electronic device in FIG. 17 may be executed by an electronic device (e.g., the electronic device 100 in FIG. 1 or the electronic device 500 in FIG. 5), an operating system (e.g., the operating system 710 in FIG. 7), or a processor (e.g., the processor 110 in FIG. 1).

The electronic device 500 according to an embodiment may receive a touch input in operation 1710. The touch input may include various types of touch input (e.g., a long press or drag) by a user (e.g., the guest or host).

The electronic device 500 according to an embodiment may identify a location where the touch input was received in operation 1720. Identifying the location where the touch input was received may include identifying the coordinates of the location where the touch input was received. For example, the electronic device 500 may identify the coordinates of the location where the touch input was received according to the second mapping table.

The electronic device 500 according to an embodiment may identify a portion where the touch input was received, based on the location where the touch input was received, in operation 1730.

The electronic device 500 may identify whether the location where the touch input was received is included in a portion 921 allocated to the host or a portion 922 allocated to the guest in the second mapping table 920. The portion allocated to the host may indicate the coordinates of a portion of the first part or the second part where the application executed by the host is displayed. The portion allocated to the guest may indicate the coordinates of a portion of the first part or the second part where the application executed by the guest is displayed.

The electronic device 500 according to an embodiment may identify the application displayed in the portion where the touch input was received in operation 1740.

Based on the location where the touch input was received, the electronic device 500 may identify whether the touch input is an input for the first application or the second application. If the location where the touch input was received is included in the first part (or the second part), the electronic device 500 may identify that the touch input is an input for the application corresponding to the execution screen displayed in the first part (or the second part). For example, when a first execution screen of the first application is displayed on the first part, the electronic device 500 may identify that the touch input received in the first part is an input for the first application.

The electronic device 500 according to an embodiment may process the touch input as an event for the identified application in operation 1750.

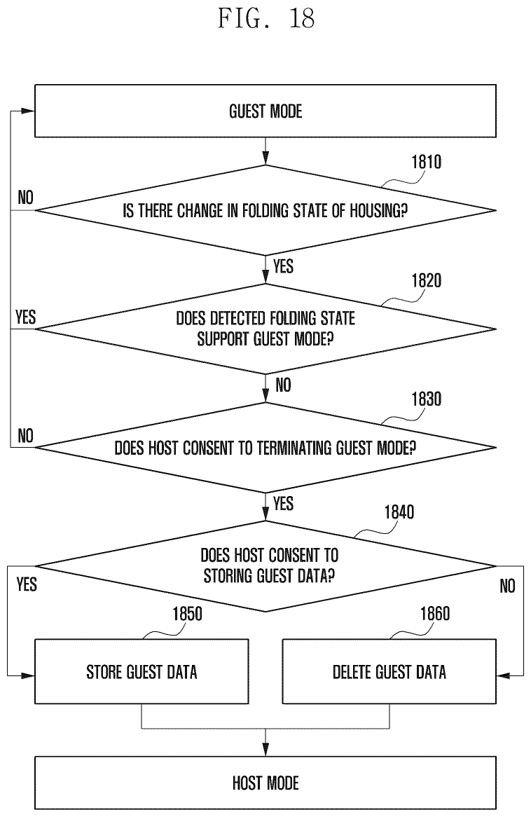

FIG. 18 is a flowchart illustrating an operation in which an electronic device executes host mode while in guest mode according to an embodiment of the disclosure.

In the following embodiment, respective operations may be performed sequentially, but are not necessarily performed sequentially. For example, the sequence of the respective operations may vary, and at least two operations may be performed in parallel.

Redundant description that has been made with reference to FIG. 1 2A, 2B, 3A, 3B, 4 to 9, 10A, 10B, 11 to 13, 14A, 14B, 15, 16, and 17 will be omitted from FIG. 18. The operations of the electronic device in FIG. 18 may be executed by an electronic device (e.g., the electronic device 100 in FIG. 1 or the electronic device 500 in FIG. 5), an operating system (e.g., the operating system 710 in FIG. 7), or a processor (e.g., the processor 110 in FIG. 1).

The electronic device 500 according to an embodiment may detect a change in the folding state of the housing in operation 1810. If there is no change in the folding state of the housing, the electronic device 500 may operate in guest mode.

If a change in the folding state of the housing is detected, the electronic device 500 according to an embodiment may identify whether the detected folding state supports guest mode in operation 1820. In the case where the detected folding state supports guest mode, the electronic device 500 may operate in guest mode.

In the case where the detected folding state does not support guest mode, the electronic device 500 according to an embodiment may identify whether the host consents to terminating guest mode in operation 1830. If the host does not consent to terminating guest mode, the electronic device 500 may operate in guest mode.

When a predetermined second user input is received, the electronic device 500 may skip operations 1810, 1820, and 1830 and perform operation 1840. The predetermined second user input may refer to a user input instructing to terminate various guest modes. For example, the predetermined second user input may include a user input for changing settings of the electronic device 500 to terminate guest mode and/or a user input for instructing to terminate a predetermined application so as to be executed in guest mode.

If the host consents to terminating guest mode, the electronic device 500 according to an embodiment may identify whether the host consents to storing guest data in operation 1840.

Guest data may refer to data related to the guest, which is generated during the execution of the guest mode. For example, the guest data may include data related to the second application (e.g., the application executed by the guest), which is generated during the execution of the guest mode.

If the host consents to storing guest data, the electronic device 500 according to an embodiment may store the guest data in operation 1850.

If the host consents to storing guest data, the electronic device 500 may store the guest data in a designated area on the memory. The electronic device 500 may store the guest data by mapping it to guest authentication information. Storing the guest data by mapping it to the guest authentication information may refer to storing guest data as information associated with the guest authentication information such that the guest data is able to be accessed only when user authentication of the guest is successful. Through user authentication, the guest may continuously use guest data generated while the guest was previously using the electronic device 500.

According to an embodiment, the electronic device 500 may also store the guest data in an area other than the designated area on the memory. For example, the electronic device 500 may store the guest data in an area of the memory where host data is stored. The electronic device 500 may identify whether the host and guest consent to storing the guest data in the area of the memory where the host data is stored. If both the host and guest consent to storing the guest data in the area of the memory where the host data is stored, the electronic device 500 may store the guest data in the area of the memory where the host data is stored. The electronic device 500 may establish a data channel connecting the area of the memory where the host data is stored and the designated area of the memory where the guest data is stored, so that the guest data is stored in the area of the memory where the host data is stored.

If the host does not consent to storing guest data, the electronic device 500 according to an embodiment may delete the guest data in operation 1860.

The electronic device 500 may operate in host mode after storing or deleting the guest data. Operating in host mode may include executing an application (e.g., an application executed by the host) in the foreground. However, the electronic device 500 may also operate in host mode separately from operation 1840 upon receiving host consent to terminate guest mode in operation 1830.

In an electronic device according to an embodiment, the electronic device may include a display. The electronic device may include memory for storing at least one computer program including a plurality of instructions. The electronic device may include at least one processor. The at least one computer program, when executed individually or collectively by the at least one processor, may cause the electronic device to determine whether a first condition for triggering execution of a plurality of applications in a foreground is satisfied. The computer program, when executed by the at least one processor, may cause the electronic device execute a first application and a second application in the foreground simultaneously and divide the display into a first part for displaying an execution screen of the first application and a second part for displaying an execution screen of the second application, in case that the first condition is satisfied. The computer program, when executed by the at least one processor, may cause the electronic device to detect an event through at least one of the first part or the second part. The computer program, when executed by the at least one processor, may cause the electronic device to determine, based on a part of the display in which a location at which the event is detected is included, an application corresponding to the event among the first application and the second application. The computer program, when executed by the at least one processor, may cause the electronic device to process the event as an event of the determined application

In an electronic device according to an embodiment, a framework layer of the operating system of the electronic device may include a resource distributor. The at least one computer program, when executed individually or collectively by the at least one processor, may cause the electronic device to configured to process an event of the first application, when the first application is determined as the application corresponding to the event. The at least one computer program, when executed individually or collectively by the at least one processor, may cause the electronic device to distribute, via the resource distributor, the event to a second event manager configured to process an event of the second application, when the second application is determined as the application corresponding to the event. Wherein the resource distributor, the first event manager and the second event manager are included in each of a plurality of manager units of a framework layer of an operating system of the electronic device

In an electronic device according to an embodiment, a kernel layer of the operating system of the electronic device may include a resource distributor. The at least one computer program, when executed individually or collectively by the at least one processor, may cause the electronic device to distribute, via a resource distributor, the event to a first driver configured to process an event of the first application, when the first application is determined as the application corresponding to the event. The at least one computer program, when executed individually or collectively by the at least one processor, may cause the electronic device to distribute, via the resource distributor, the event to a second driver configured to process an event of the second application, when the second application is determined as the application corresponding to the event. Wherein the resource distributor, the first driver and the second driver are included in each of a plurality of driving units of a kernel layer of an operating system of the electronic device.

In an electronic device according to an embodiment, the at least one computer program, when executed individually or collectively by the at least one processor, may cause the electronic device to identify a location of a user input received on the display, the user input being related to the event. The computer program, when executed by the at least one processor, may cause the electronic device to determine that the user input is an input to the first application in case that the received location of the user input is included in the first part. The computer program, when executed by the at least one processor, may cause the electronic device to determine that the user input is an input to the second application in case that the received location of the user input is included in the second part.

In an electronic device according to an embodiment, the at least one computer program, when executed individually or collectively by the at least one processor, may cause the electronic device to terminate the second application or execute it in the background while executing the first application in the foreground, when a second condition for triggering execution of one application in the foreground is satisfie. The computer program, when executed by the at least one processor, may cause the electronic device to allocate both of the first part and the second part of the display to the first application.

In an electronic device according to an embodiment, the at least one computer program, when executed individually or collectively by the at least one processor, may cause the electronic device to, in response to the second application being terminated or executed in the background, store, information, generated during the execution of the second application in the foreground, in a designated area of the memory, based on whether a consent of a user registered as a host of the electronic device is obtained.

In an electronic device according to an embodiment, the first conditions may include receiving a user input instructing two applications to be executed in the foreground and/or receiving a user input instructing a predetermined application to be executed to execute a plurality of applications in the foreground.

In an electronic device according to an embodiment, the first and second applications may be controlled by different users. The events of each of the first and second applications may include at least one of user input including touch input, notification output, content output, or Bluetooth connection with an external electronic device.

In an electronic device according to an embodiment, wherein the first part includes a part for which user authentication of a user registered as a host of the electronic device is successful.

An electronic device according to an embodiment may include a housing including a first housing portion, a second housing portion, and a third housing portion. The electronic device may include at least one sensor for detecting a folding state of the housing. The display may include a first display area disposed on the first housing portion, a second display area disposed on the second housing portion, a third display area disposed on the third housing portion. The first condition may include a condition in which a predetermined folding state of the housing is detected.

In an electronic device according to an embodiment, the predetermined folding state of the housing may include a first folding state configured such that the first part includes the first display area and the second display area, and the second part includes the third display area, and a second folding state configured such that the first part includes the first display area, and the second part includes the second display area and the third display area.

In a method for executing a plurality of applications in the foreground i an electronic device, the method may include determining whether a first condition for triggering execution of a plurality of applications in a foreground is satisfied. The method may include executing a first application and a second application in the foreground simultaneously and dividing the display into a first part for displaying an execution screen of the first application and a second part for displaying an execution screen of the second application, in case that the first condition is satisfied. The method may include detecting an event through at least one of the first part or the second part. The method may include determining, based on a part of the display in which a location at which the event is detected is included, an application corresponding to the event among the first application and the second application. The method may include processing the event as an event of the determined application.

In the method for executing a plurality of applications in the foreground in an electronic device, the method may include distributing, via a resource distributor, the event to a first event manager configured to process an event of the first application, when the first application is determined as the application corresponding to the event. The method may include distributing, via the resource distributor, the event to a second event manager configured to process an event of the second application, when the second application is determined as the application corresponding to the event. wherein the resource distributor, the first event manager and the second event manager are is included in each of a plurality of manager units of a framework layer of an operating system of the electronic device

In the method for executing a plurality of applications in the foreground in an electronic device, the method may include distributing, via a resource distributor, the event to a first driver configured to process an event of the first application, when the first application is determined as the application corresponding to the event. The method may include distributing, via the resource distributor, the event to a second driver configured to process an event of the second application, when the second application is determined as the application corresponding to the event. Wherein the resource distributor, the first driver and the second driver are included in each of a plurality of driving units of a kernel layer of an operating system of the electronic device

The method for executing a plurality of applications in the foreground in an electronic device may include identifying a location of a user input received on the display, the user input being related to the event. The method may include determining that the user input is an input to the first application in case that the received location of the user input is included in the first part. The method may include determining that the user input is an input to the second application in case that the received location of the user input is included in the second part.

The method for executing a plurality of applications in the foreground in an electronic device may include terminating the second application or executing it in the background when predetermined second conditions are satisfied. The method may include allocating the display to the application running in the foreground.

In the method for executing a plurality of applications in the foreground in an electronic device, the first and second applications may be controlled by different users. The events of each of the first and second applications may include at least one of user input including touch input, notification output, content output, or Bluetooth connection with an external electronic device.

In the method for executing a plurality of applications in the foreground in an electronic device, the first part may includes a part for which user authentication of a user registered as a host of the electronic device is successful.

In the method for executing a plurality of applications in the foreground in an electronic device, the electronic device may include a housing including a first housing portion, a second housing portion, and a third housing portion. The electronic device may include at least one sensor for detecting a folding state of the housing. A display included in the electronic device may include a first display area disposed on the first housing portion, a second display area disposed on the second housing portion, a third display area disposed on the third housing portion. The first conditions may include a condition in which a predetermined folding state of the housing is detected.

In the method for executing a plurality of applications in the foreground in an electronic device, the predetermined folding state of the housing may include a first folding state configured such that the first part includes the first display area and the second display area, and the second part includes the third display area, and a second folding state configured such that the first part includes the first display area, and the second part includes the second display area and the third display area.

The electronic device according to various embodiments disclosed herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

An embodiment as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 110) of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each element (e.g., a module or a program) of the above-described elements may include a single entity or multiple entities, and some of the multiple entities mat be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory storing at least one computer program including instructions; and
at least one processor communicatively coupled to the display and the memory,
wherein the at least one computer program, when executed individually or collectively by the at least one processor, cause the electronic device to:
determine whether a first condition for triggering execution of a plurality of applications in a foreground is satisfied,
execute a first application and a second application in the foreground simultaneously and divide the display into a first part for displaying an execution screen of the first application and a second part for displaying an execution screen of the second application, in case that the first condition is satisfied,
detect an event through at least one of the first part or the second part,
determine, based on a part of the display in which a location at which the event is detected is included, an application corresponding to the event among the first application and the second application, and
process the event as an event of the determined application.

2. The electronic device of claim 1,
wherein the at least one computer program, when executed individually or collectively by the at least one processor, further cause the electronic device to:
distribute, via a resource distributor, the event to a first event manager configured to process an event of the first application, when the first application is determined as the application corresponding to the event, and
distribute, via the resource distributor, the event to a second event manager configured to process an event of the second application, when the second application is determined as the application corresponding to the event, and
wherein the resource distributor, the first event manager and the second event manager are included in each of a plurality of manager units of a framework layer of an operating system of the electronic device.

3. The electronic device of claim 1,
wherein the at least one computer program, when executed individually or collectively by the at least one processor, further cause the electronic device to:
distribute, via a resource distributor, the event to a first driver configured to process an event of the first application, when the first application is determined as the application corresponding to the event, and
distribute, via the resource distributor, the event to a second driver configured to process an event of the second application, when the second application is determined as the application corresponding to the event, and
wherein the resource distributor, the first driver and the second driver are included in each of a plurality of driving units of a kernel layer of an operating system of the electronic device.

4. The electronic device of claim 1, wherein the at least one computer program, when executed individually or collectively by the at least one processor, further cause the electronic device to:
identify a location of a user input received on the display, the user input being related to the event,
determine that the user input is an input to the first application in case that the received location of the user input is included in the first part, and
determine that the user input is an input to the second application in case that the received location of the user input is included in the second part.

5. The electronic device of claim 1, wherein the at least one computer program, when executed individually or collectively by the at least one processor, further cause the electronic device to:
terminate or execute in a background, the second application while executing the first application in the foreground, when a second condition for triggering execution of one application in the foreground is satisfied, and
allocate both of the first part and the second part of the display to the first application.

6. The electronic device of claim 5, wherein the at least one computer program, when executed individually or collectively by the at least one processor, further cause the electronic device to:
in response to the second application being terminated or executed in the background, store, in a designated area of the memory, information generated while the second application was running in the foreground, based on whether a consent of a user registered as a host of the electronic device is obtained.

7. The electronic device of claim 1, wherein the first condition includes at least one of:
a user input for instructing two applications to execute in the foreground, or
a user input for instructing an application configured to execute a plurality of applications in the foreground.

8. The electronic device of claim 1, wherein the first and second applications are controlled by different users, and the events of the first and second applications include at least one of:
a user input including a touch input, a notification output, content output, or a Bluetooth connection with an external electronic device.

9. The electronic device of claim 1, wherein the first part includes a part for which user authentication of a user registered as a host of the electronic device is successful.

10. The electronic device of claim 1, further comprising:
a housing including a first housing portion, a second housing portion, and a third housing portion; and
at least one sensor detecting a folding state of the housing,
wherein the display includes a first display area disposed on the first housing portion, a second display area disposed on the second housing portion, a third display area disposed on the third housing portion, and
wherein the first condition includes a condition in which a predetermined folding state of the housing is detected.

11. The electronic device of claim 10, wherein the predetermined folding state of the housing includes:
a first folding state in which the first part includes the first display area and the second display area, and the second part includes the third display area, and
a second folding state in which the first part includes the first display area, and the second part includes the second display area and the third display area.

12. A method for executing a plurality of applications in a foreground of an electronic device, the method comprising:
determining whether a first condition for triggering execution of a plurality of applications in a foreground is satisfied,
executing a first application and a second application in the foreground simultaneously and dividing the display into a first part for displaying an execution screen of the first application and a second part for displaying an execution screen of the second application, in case that the first condition is satisfied,
detecting an event through at least one of the first part or the second part,
determining, based on a part of the display in which a location at which the event is detected is included, an application corresponding to the event among the first application and the second application, and
processing the event as an event of the determined application.

13. The method of claim 12, further comprising:
distributing, via a resource distributor, the event to a first event manager configured to process an event of the first application, when the first application is determined as the application corresponding to the event, and
distributing, via the resource distributor, the event to a second event manager configured to process an event of the second application, when the second application is determined as the application corresponding to the event,
wherein the resource distributor, the first event manager and the second event manager are is included in each of a plurality of manager units of a framework layer of an operating system of the electronic device.

14. The method of claim 12, further comprising:
distributing, via a resource distributor, the event to a first driver configured to process an event of the first application, when the first application is determined as the application corresponding to the event, and
distributing, via the resource distributor, the event to a second driver configured to process an event of the second application, when the second application is determined as the application corresponding to the event,
wherein the resource distributor, the first driver and the second driver are included in each of a plurality of driving units of a kernel layer of an operating system of the electronic device.

15. The method of claim 12, further comprising:
identifying a location of a user input received on the display, the user input being related to the event,
determining that the user input is an input to the first application in case that the received location of the user input is included in the first part; and
determining that the user input is an input to the second application in case that the received location of the user input is included in the second part.

16. The method of claim 12, further comprising:
terminating or executing in a background, the second application while executing the first application in the foreground, when a second condition for triggering execution of one application in the foreground is satisfied; and
allocating both of the first part and the second part of the display to the first application.

17. The method of claim 12,
wherein the first and second applications are controlled by different users, and
wherein the events of the first and second applications include at least one of a user input including touch input, a notification output, content output, or a Bluetooth connection with an external electronic device.

18. The method of claim 12, the first part includes a part for which user authentication of a user registered as a host of the electronic device is successful.

19. The method of claim 12,
wherein the electronic device includes:
a housing including a first housing portion, a second housing portion, and a third housing portion, and
at least one sensor detecting a folding state of the housing, and
wherein the display includes a first display area disposed on the first housing portion, a second display area disposed on the second housing portion, a third display area disposed on the third housing portion, and
wherein the predetermined first condition includes a condition in which a predetermined folding state of the housing is detected.

20. The method of claim 19, wherein the predetermined folding state of the housing includes:
a first folding state in which the first part includes the first display area and the second display area, and the second part includes the third display area, and
a second folding state in which the first part includes the first display area, and the second part includes the second display area and the third display area.
